(19) United States
(12) Patent Application Publication
(10) Pub. No.: US 2023/0064968 A1
(43) Pub. Date: Mar. 2, 2023

(54) LITHIUM RECOVERY FROM BRNIE

(71) Applicant: BHER Minerals, LLC, Des Moines, IA (US)

(72) Inventors: Eric SMITH, Des Moines, IA (US); Chad SMITH, Johnston, IA (US); John Michael McNAMARA, Indio, CA (US)

(21) Appl. No.: 17/818,949

(22) Filed: Aug. 10, 2022

Related U.S. Application Data
(60) Provisional application No. 63/232,887, filed on Aug. 13, 2021.

(51) Int. Cl. C01D 15/04; C01D 15/02; B01J 39/02; B01J 39/09; B01J 47/018; B01J 49/53; C22B 26/12; C22B 3/42

(52) U.S. Cl. CPC C01D 15/04; C01D 15/02; B01J 39/02; B01J 39/09; B01J 47/018; B01J 49/53; C22B 26/12; C22B 3/42

(57) ABSTRACT

Provided herein are processes for recovering lithium ions from a brine source. The process can comprises increasing the pH of a brine source comprising lithium ions to at least about 5.5; contacting the pH-elevated brine source with a bed of protonated ion exchange media to produce a lithiated ion exchange media and a lithium-depleted brine stream; contacting the lithiated ion exchange media with an acidic aqueous wash liquid; and contacting the washed lithiated ion exchange media with an elution liquid comprising an acid. Also provided herein is a process for increasing the pH of brine comprising obtaining brine from a brine source comprising lithium ions; adding the brine to a continuously stirred tank reactor without preprocessing the brine to remove solid matter; adding a strong base to the continuously stirred tank reactor; contacting the brine with the base. Further provided herein are processes for creating a lithiated ion exchange media, which can comprise contacting a pH-elevated brine source with a bed of protonated ion exchange media; and producing a lithiated ion exchange media and a spent brine, wherein the bed of protonated ion exchange media comprises a metal oxide absorbent and a polymeric binder.

This application claims the benefit of U.S. Provisional Application No. 63/232,887, filed Aug. 13, 2021, which is incorporated herein by reference in its entirety.

Provided herein are processes for the recovery of lithium ions from a brine source. Also provided herein are processes for the manufacture of lithium hydroxide from the recovered lithium ions. These and other processes are described in detail below.

Lithium and lithium salts are important for use in numerous industries. For example, lithium salts can be converted into lithium hydroxide, for use in lithium-ion batteries (e.g., for electric vehicles). Brine sources, such as geothermal brines, may contain lithium ions in a sufficient concentration that permits the efficient and economical recovery of lithium ions from the brine. One technique used in the recovery of lithium values from brine sources is ion exchange.

In previous ion exchange processes for the recovery of lithium ions from a brine source, precipitates were formed during the processing and it was necessary to remove a majority of the precipitates in order to be able to efficiently recover the lithium from the processed brine. Further, when the brine is a geothermal brine, it has sometimes been necessary to cool the brine before ion exchange to avoid damaging the ion exchange media. However, the need for cooling complicates the process and produces additional precipitates (e.g., salt crystals) that have to be removed before recovery of lithium.

Accordingly, there remains a need in the art to develop processes wherein lithium can be efficiently recovered from a brine source, even when the brine source is at an elevated temperature and/or has an elevated solids (e.g., salt crystals and/or precipitates) content. Additionally, there remains a need in the art to develop improved ion exchange processes, wherein lithium can be efficiently and economically recovered from a brine source.

Provided herein are processes for recovering lithium ions from a brine source. In one embodiment, the process comprises: increasing the pH of a brine source comprising lithium ions to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; and contacting the washed lithiated ion exchange media with an elution liquid comprising an acid to form a regenerated protonated ion exchange media having a reduced lithium ion content and an ion exchange salt solution containing lithium ions eluted from the lithiated ion exchange media.

In another embodiment, the process comprises: increasing the pH of a brine source comprising lithium ions to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; contacting the washed lithiated ion exchange media with an elution liquid comprising an acid to form a regenerated protonated ion exchange media having a reduced lithium ion content and an ion exchange salt solution containing lithium ions eluted from the lithiated ion exchange media; and contacting the brine depleted in lithium ions with an acid in three continuously stirred tank reactors (CSTRs), wherein the pH of the lithium-depleted brine stream is lowered once in a first CSTR, lowered a second time in a second CSTR, and lowered a third time in a third CSTR to obtain a lithium-depleted brine having a pH that is about equal to the brine source.

In a further embodiment, the process comprises: increasing the pH of a brine source comprising lithium ions to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; contacting the washed lithiated ion exchange media with an elution liquid comprising an acid to form a regenerated protonated ion exchange media having a reduced lithium ion content and an ion exchange salt solution containing lithium ions eluted from the lithiated ion exchange media; and contacting the brine depleted in lithium ions with an acid in three CSTRs, wherein the pH of the lithium-depleted brine stream is lowered once, step-wise in each CSTR to obtain a lithium-depleted brine having a pH that is about equal to the brine source.

In yet another embodiment, the process comprises: increasing the pH of the brine source to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; contacting the washed lithiated ion exchange media with a gas in a purge step to produce a purged washed lithiated ion exchange media; contacting the purged washed lithiated ion exchange media with an elution liquid comprising an acid to form a regenerated protonated ion exchange media having a reduced lithium ion content and an ion exchange salt solution containing lithium ions eluted from the lithiated ion exchange media; and contacting the regenerated protonated ion exchange media with a gas to produce a purged regenerated protonated ion exchange media.

In addition, provided herein is a process for increasing the pH of brine. The process comprises obtaining brine from a brine source comprising lithium ions; adding the brine to a CSTR without preprocessing the brine to remove solid matter; adding a strong base to the CSTR; contacting the brine with the base to form a pH-elevated brine; wherein the pH-elevated brine has a pH of at least about 5.5 or greater, wherein the pH elevation does not create large solids or increase the temperature of the brine.

Also provided herein are processes for creating a lithiated ion exchange media. In one embodiment, the process comprises: contacting a pH-elevated brine source with a bed of protonated ion exchange media; producing a lithiated ion exchange media and a spent brine, wherein the bed of protonated ion exchange media comprises a metal oxide absorbent and a polymeric binder.

In another embodiment for creating a lithiated ion exchange media, the process comprises: contacting a pH-elevated brine source with a bed of protonated ion exchange media; producing a lithiated ion exchange media and a lithium-depleted brine stream with a pH of about 7.5, wherein the bed of protonated ion exchange media comprises a metal oxide absorbent; and contacting the lithium-depleted brine stream with an acid in three CSTRs, wherein the lithium-depleted brine stream has a pH of about 7.5 and is acidified in a first CSTR to a pH from about 6.5 to about 7.0 at an outlet of the first CSTR, then in a second CSTR is dropped to a pH range of about 5.5 to about 6.5 at an outlet of the second CSTR and then in a CSTR is further dropped to a pH range of about 4.5 to about 5.5 at an outlet of the CSTR.

Further provided herein is a process for washing lithiated ion exchange media. The process comprises: contacting a lithiated ion exchange media with an acidic aqueous wash liquid, wherein the acidic aqueous wash liquid comprises deionized water, reverse osmosis water, reclaimed water from another location in the process, brine, other liquid having a pH of below about 7.0, or combinations thereof.

Finally, provided herein is a process for eluting lithium salts from a brine source, the process comprising: contacting a lithiated ion exchange media with an acid, wherein the acid is a mineral acid, producing a lithium-ion salt solution with an acidic pH; and contacting the lithium-ion salt solution with the lithiated ion exchange media.

Other objects and features will be in part apparent and in part pointed out hereinafter.

### DESCRIPTION OF THE DRAWINGS

FIG. 1 is a schematic flow diagram of a process for the recovery of lithium from a brine source, including pH elevation of the brine source, lithium recovery from the pH-elevated brine source, and brine post treatment.

FIGS. 2 and 3 are schematic flow diagrams of an ion exchange system comprising multiple ion exchange vessels in which lithium adsorption is carried out in two steps (i.e., Step 1A and Step 1B) in two ion exchange vessels in series to produce a lithiated ion exchange media and a brine depleted in lithium ions.

FIGS. 4 and 5 are schematic flow diagrams of an ion exchange system comprising multiple ion exchange vessels in which washing of the lithiated ion exchange media is carried out in a two-step (i.e., Step 2A and Step 2B) procedure to produce a washed lithiated ion exchange media.

FIG. 6 is a schematic flow diagram of an ion exchange system comprising multiple ion exchange vessels in which a gas purge step is used to produce a purged washed lithiated ion exchange media.

FIG. 7 is a schematic flow diagram of an ion exchange system comprising multiple ion exchange vessels in which a lithium-ion elution step is used to produce an ion exchange salt solution containing lithium ions eluted from the purged washed lithiated ion exchange media and a regenerated protonated ion exchange media having a reduced lithium ion content.

FIG. 8 is a schematic flow diagram of an integrated process for the production of lithium hydroxide from a brine source, including generating a lithium salt-containing solution by ion exchange of a pH-elevated brine source and subjecting the lithium salt-containing solution to electrolysis to produce lithium hydroxide.

Corresponding reference characters indicate corresponding parts throughout the drawings.

### DETAILED DESCRIPTION

In accordance with the present disclosure, processes for the recovery of lithium from a brine source have been devised that reduce or eliminate the need for processing the brine (e.g., solid/liquid separation) prior to lithium recovery and take advantage of the thermal energy present in various brine sources, including geothermal brines. As used herein, “brine” means, but is not limited to, any lithium ion-containing liquid. Examples of brine include, but are not limited to, geothermal brines, salar brines, drilling fluids, lake water, and salt water. In particular, the processes of the present disclosure utilize an ion exchange system to selectively recover lithium ions from the brine source in the presence of other metal ions or salts and suspended solids that have previously complicated lithium recovery from such sources. By allowing processing of brine sources at elevated temperatures, the need for cooling and associated capital costs are eliminated. Additionally, in certain aspects of the present disclosure, a higher temperature enhances the adsorption and elution kinetics.

Processes of the present disclosure are also directed to the recovery of lithium from a brine source utilizing an ion exchange system that includes various wash and gas purge steps after adsorption. These processes result in a lithium salt product that may require less post-production processing to prepare a commercially acceptable product. Additionally, the ion exchange system may reduce the overall capital costs of the process.

In one embodiment, the process comprises: increasing the pH of a brine source comprising lithium ions to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; and contacting the washed lithiated ion exchange media with an elution liquid comprising an acid to form a regenerated protonated ion exchange media having a reduced lithium ion content and an ion exchange salt solution containing lithium ions eluted from the lithiated ion exchange media.

In another embodiment, the process comprises: increasing the pH of a brine source comprising lithium ions to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; contacting the washed lithiated ion exchange media with an elution liquid comprising an acid to form a regenerated protonated ion exchange media having a reduced lithium ion content and an ion exchange salt solution containing lithium ions eluted from the lithiated ion exchange media; and contacting the brine depleted in lithium ions with an acid in three CSTRs, wherein the pH of the lithium-depleted brine stream is lowered once in a first CSTR, lowered a second time in a second CSTR, and lowered a third time in a third CSTR to obtain a lithium-depleted brine having a pH that is about equal to the brine source.

In a further embodiment, the process comprises: increasing the pH of a brine source comprising lithium ions to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; contacting the washed lithiated ion exchange media with an elution liquid comprising an acid to form a regenerated protonated ion exchange media having a reduced lithium ion content and an ion exchange salt solution containing lithium ions eluted from the lithiated ion exchange media; and contacting the brine depleted in lithium ions with an acid in three CSTRs, wherein the pH of the lithium-depleted brine stream is lowered once, step-wise in each CSTR to obtain a lithium-depleted brine having a pH that is about equal to the brine source.

In yet another embodiment, the process comprises: increasing the pH of the brine source to at least about 5.5 or greater to produce a pH-elevated brine source; contacting the pH-elevated brine source with a bed of protonated ion exchange media to produce a lithiated ion exchange media and a lithium-depleted brine stream; contacting the lithiated ion exchange media with an acidic aqueous wash liquid to produce a washed lithiated ion exchange media; contacting the washed lithiated ion exchange media with a gas in a purge step to produce a purged washed lithiated ion exchange media; contacting the purged washed lithiated ion exchange media with an elution liquid comprising an acid to form a regenerated protonated ion exchange media having a reduced lithium ion content and an ion exchange salt solution containing lithium ions eluted from the lithiated ion exchange media; and contacting the regenerated protonated ion exchange media with a gas to produce a purged regenerated protonated ion exchange media.

The present disclosure is further directed to an integrated process for the production of lithium hydroxide from a brine source, including generating a lithium salt-containing solution by ion exchange of a brine source and subjecting the lithium salt-containing solution to electrolysis to produce lithium hydroxide.

The brine source used in the processes of the present disclosure may be any lithium ion-containing brine suitable for processing as described herein. In certain embodiments, the brine source is a geothermal brine. For example, when the brine source is a geothermal brine, the geothermal brine may be a brine directly removed from a geothermal well, a processed geothermal brine, or post-flash brine geothermal brine produced in an upstream geothermal energy production facility following recovery of energy from the brine. In one embodiment, the brine source comprises a geothermal brine derived from the Salton Sea Known Geothermal Resource Area (SSKGRA) located in Imperial Valley, Calif., U.S.A. Many geothermal brines, such as those derived from the SSKGRA, although rich in lithium values, present specific problems in carrying out recovery of lithium by ion exchange, including elevated temperatures, high silicon-containing compound (e.g., silica) content, and the presence of other metal ions. The term silica may be used herein. However, it will be understood that the process as described is equally applicable to brines or streams containing other silicon-containing compounds (e.g., SiO₂, Si(OH)₄, etc.). In addition to silica, geothermal brines such as those derived from the SSKGRA typically include appreciable concentrations of one or more metal ions that may be present in various compounds (e.g., silicates), including, but not limited to, lithium, iron, manganese, magnesium, zinc, potassium, sodium, calcium, lead, barium, arsenic, boron, strontium, cadmium, chromium, and copper. In another embodiment, the brine source is a non-geothermal brine containing lithium ions, for example, a brine from a non-geothermal underground brine source. In one embodiment, the non-geothermal brine is a Smackover brine, for example, a brine derived from the Upper Jurassic (Oxfordian) Smackover Formation located in parts of Texas, Louisiana, Arkansas, Mississippi, Alabama, Georgia, and Florida.

In accordance with one embodiment of the present disclosure, an ion exchange recovery process has been devised that advantageously allows operation at relatively high brine source temperatures and suspended solids contents.

In some embodiments, the brine source contacted with the ion exchange media is maintained at a temperature of about 50° C. or greater, such as, for example, about 60° C. or greater, about 65° C. or greater, about 70° C. or greater, about 75° C. or greater, about 80° C. or greater, about 85° C. or greater, about 90° C. or greater, about 95° C. or greater, about 100° C. or greater, about 105° C. or greater, or about 110° C. or greater.

The processes disclosed herein include a pH elevation step in which the pH of the brine source is increased to form a pH-elevated brine that improves the kinetics of lithium adsorption when contacted with the ion exchange media. In certain embodiments, the pH elevation step also causes the precipitation of silicon-containing compounds (e.g., silica) and one or more metal ions (e.g., in the form of metal hydroxides) to form a pH-elevated brine having precipitates suspended therein. However, regardless of whether additional precipitates are formed in the pH-adjustment step, the process of the present disclosure does not require significant pre-processing steps prior to the ion exchange operation to remove or reduce the solids content or reduce the temperature of the brine source. The processes disclosed herein allow ion exchange operations to be conducted at elevated temperatures and in the presence of suspended solids in the brine.

The brine source may comprise a spent (e.g., reduced enthalpy) geothermal brine flowing from an upstream geothermal energy production facility. In a geothermal power production facility, brine is extracted from production wells in a known geothermal resource area (e.g., the SSKGRA) and is used as a heat source for the generation of geothermal power. In a typical geothermal power production facility, super-heated brine (i.e., high enthalpy, hypersaline geothermal brine) with a high temperature (e.g., greater than 230° C.) and pressure (e.g., greater than 350 psia) from sub-surface depths exceeding 4,000 feet is used to generate power. This high temperature geothermal brine is brought to the surface, where steam is separated (i.e., flashed) from the brine and directed to one or more turbines to generate electricity. For example, a geothermal brine may be introduced into a series of separators, during which steam is removed and directed to one or more turbines to generate power. After steam is flashed from the geothermal brine and sent to the turbines, the concentration of dissolved solids is increased and the enthalpy of the brine is reduced (i.e., the brine has been “spent”). Due to the increased dissolved solids concentration and the reduced brine enthalpy, solids will precipitate and/or crystalize in the remaining spent brine. The brine that remains after the steam has been recovered, along with condensate from the steam cycle, is processed and returned to the geothermal well. Reinjection of the brine ensures sustainable management of the geothermal reservoir by replenishing the geothermal fluids that were used for power generation. Further, certain governmental entities or regulations require, as a term of operation of the geothermal power facility, that a certain percentage of the fluids withdrawn from a geothermal reservoir are reinjected. For example, the California Department of Conservation Division of Oil, Gas and Geothermal Resources (now known as the California Geological Energy Management Division, or CalGEM) requires reinjection of at least 75% of the fluids withdrawn from the geothermal reservoir.

Solids are typically removed from the spent brine at various locations in the power production process prior to reinjection into the well to ensure proper control of the process and avoid plugging or other mechanical issues associated with injecting the spent brine containing solids into injection wells and/or through process pipelines. The spent brine containing solids may be sent to a reactor, crystallizer, and/or clarifier vessels in order to facilitate the removal of the solids prior to the eventual reinjection of the remaining brine into the geothermal well.

For example, the spent brine may be directed to one or more clarifiers and/or thickeners to remove solids. The main purpose of the clarifier and/or thickener system(s) is to allow the solids to settle out of the spent brine stream by gravity. Both clarifiers and thickeners preferentially separate solids in the “underflow” slurry outlet stream. The remaining brine and solids exit the clarifier, or thickener, in the so called “overflow” stream. In one embodiment, the process may comprise two clarifiers. In the primary clarifier, solids are allowed to settle and the overflow stream from the primary clarifier is directed to the inlet of the secondary clarifier. In the secondary clarifier, further solids are allowed to settle. The solids that settle in the primary and secondary clarifiers are removed in the respective underflow streams. The underflow streams are directed to further processing to remove the solids in the form of a filter cake and prepare an aqueous component of the underflow stream for reinjection into the geothermal well. The underflow stream exiting the secondary clarifier may also be subjected to filtration to recover a solids filter cake and an aqueous component for reinjection into the geothermal reservoir. This filtration may take place, for example, by a filter press operation. In a filter press operation, sludge from the underflow streams (i.e., sludge with heavy solids that are withdrawn from the lower regions of the clarifiers) is sent to a filter press where liquid is removed by a solid/liquid separation process. At the conclusion of the solid/liquid separation operation, the solids form a filter cake and can be disposed of using known methods.

The sludge from the clarifier underflow streams may be passed through a heat exchanger prior to entering the filter press. The heat exchanger functions to cool the underflow streams, for example, from about 105° C. to about 75° C. A small amount of hydrochloric acid may be added to the sludge at the heat exchanger stage to reduce the potential for metals precipitating from the brine slurry during the decrease in temperature. The underflow streams and/or fluid stream exiting the secondary clarifier may be contacted with an acid before or after filtration to dissolve or suspend certain solids. For example, a hydrochloric acid solution may be injected into the stream to decrease the pH and thereby inhibit silica and other scale-forming elements from precipitating out of solution. Further, the underflow stream exiting the primary or secondary clarifier may be recycled upstream, where the recycled solids act as nucleation sites to facilitate solids precipitation in the clarifier and/or thickener system(s).

In addition to the optional addition of acid to the outlet streams exiting the clarifier/thickener system, acid may be added in various brine-steam separator areas of the steam flashing process (where brine is separated from steam) in order to prevent silica and other scale-forming elements from precipitating out of solution and/or forming scaling on the piping or process equipment. Further, a base such as calcium hydroxide (Ca(OH)₂) or a flocculant (e.g., Nalco® 9907) may be used to inhibit scaling in the geothermal energy production process. These additional chemicals minimize the formation of scale deposition while enhancing the eventual formation of the solids that are removed in subsequent solid/liquid separation process steps (e.g., a filter cake). For example, a flocculant may be used to form large aggregated precipitate particles that will settle more easily in the clarifier system.

The spent brine may be contacted with a base (e.g., lime) prior to entering the clarifiers and/or thickeners. The addition of lime allows for further precipitation and increased removal of solids in the clarifier and/or thickener system. For example, the spent brine may be subjected to a crystallization step in one or more crystallization reactors to form an aqueous crystallization stream and a solids stream. In the crystallization step, solids from subsequent steps (e.g., clarifiers or post-clarifier filtration) are re-circulated to the crystallization reactors as seeds (i.e., nuclei or nucleation sites), to enhance the precipitation process. The “seed recycle” encourages the precipitating solids to grow on the seeds instead of on the surfaces of the vessels, pipes, valves, and pumps.

The brine source selected for lithium recovery in accordance with the present disclosure may be any lithium ion-containing brine suitable for processing as described herein. In one embodiment, the brine source comprises a non-geothermal brine containing lithium ions. In one embodiment, the non-geothermal brine is a Smackover brine, for example, a brine derived from the Upper Jurassic (Oxfordian) Smackover Formation located in parts of Texas, Louisiana, Arkansas, Mississippi, Alabama, Georgia, and Florida. In certain other embodiments, the brine source is derived from any of the various spent geothermal brine process streams described above, prior to, during, or after solids removal. In accordance with one embodiment, at least a portion of the overflow from one or more of the clarifiers (e.g., from the secondary clarifier) containing clarified brine that is significantly reduced in solids content may be directed to lithium recovery. Any remaining portion of the clarified brine may be reinjected into the geothermal well. In accordance with another embodiment, at least a portion of the aqueous crystallization stream from the crystallization reactors upstream of the clarifier and/or thickener systems and containing appreciable quantities of dissolved and suspended solids may be directed to lithium recovery. Any remaining portion of the aqueous crystallization stream may be further treated for solids removal before eventual reinjection into the geothermal well.

As noted previously, in certain embodiments, the brine source of the present lithium recovery process is a geothermal brine. When the brine source is a geothermal brine, the geothermal brine may be a brine removed from a geothermal well, a processed geothermal brine, a spent geothermal brine produced in an upstream geothermal energy production facility following extraction of energy (e.g., in the form of steam) from the brine, or any other suitable geothermal brine.

When the brine source is a spent geothermal brine flowing from an upstream geothermal energy facility as described above, the brine source can be selected from one or more of the spent brine, aqueous crystallization outlet streams, or clarifier and/or thickener system overflow streams. In certain embodiments, the brine source is a spent brine recovered before crystallization, clarification, thickening, and/or additional solid/liquid separation steps.

The suspended solids content of the brine source subjected to lithium recovery may vary considerably depending on its origins and any upstream processing. Typically, the solids content of the brine source will range from about 10 ppm by weight up to and exceeding 10.0 wt %. In one embodiment, the brine source has a solids content of about 10 ppm or greater, about 25 ppm or greater, about 50 ppm or greater, about 75 ppm or greater, about 100 ppm or greater, about 200 ppm or greater, about 300 ppm or greater, about 400 ppm or greater, about 500 ppm or greater, about 0.1 wt % or greater, about 0.2 wt % or greater, about 0.3 wt % or greater, about 0.4 wt % or greater, about 0.5 wt % or greater, about 1.0 wt % or greater, about 2.0 wt % or greater, about 3.0 wt % or greater, about 4.0 wt % or greater, about 5.0 wt % or greater, about 6.0 wt % or greater, about 7.0 wt % or greater, about 8.0 wt % or greater, about 9.0 wt % or greater, or about 10.0 wt % or greater. For example, the brine source may have a solids content of from about 10 ppm to about 10.0 wt %, from about 10 ppm to about 8.0 wt %, from about 10 ppm to about 7.0 wt %, from about 10 ppm to about 6.0 wt %, from about 10 ppm to about 5.0 wt %, from about 50 ppm to about 5.0 wt %, from about 100 ppm to about 5.0 wt %, from about 500 ppm to about 5.0 wt %, from about 0.1 wt % to about 5.0 wt %, from about 0.5 wt % to about 5.0 wt %, from about 1.0 wt % to about 5.0 wt %, from about 1.0 wt % to about 4.0 wt %, from about 1.0 wt % to about 3.0 wt %, or from about 2.0 wt % to about 3.0 wt %. In one embodiment, the brine source is a spent geothermal brine having a solids content of from about 10 ppm to about 10.0 wt %, from about 100 ppm to about 10.0 wt %, from about 500 ppm to about 10.0 wt %, from about 0.1 wt % to about 10.0 wt %, from about 0.5 wt % to about 10.0 wt %, from about 1.0 wt % to about 10.0 wt %, from about 2.0 wt % to about 10.0 wt %, from about 3.0 wt % to about 10.0 wt %, from about 4.0 wt % to about 10.0 wt %, or from about 5.0 wt % to about 10.0 wt %. In another embodiment, the brine source is a clarifier and/or thickener system overflow stream from geothermal operations having a solids content of from about 10 ppm to about 10.0 wt %, from about 10 ppm to about 5.0 wt %, from about 10 ppm to about 4.0 wt %, from about 10 ppm to about 3.0 wt %, from about 10 ppm to about 2.0 wt %, from about 10 ppm to about 1.0 wt %, from about 100 ppm to about 1.0 wt %, from about 500 ppm to about 1.0 wt %, from about 0.1 wt % to about 1.0 wt %, from about 0.2 wt % to about 1.0 wt %, from about 0.3 wt % to about 1.0 wt %, from about 0.4 wt % to about 1.0 wt %, from about 0.5 wt % to about 1.0 wt %, from about 0.6 wt % to about 1.0 wt %, from about 0.7 wt % to about 1.0 wt %, from about 0.8 wt % to about 1.0 wt %, or from about 0.9 wt % to about 1.0 wt %.

In certain embodiments, the brine source is a spent brine recovered before crystallization, clarification, and/or solid/liquid separation steps and is present at a temperature of about 50° C. or greater, about 60° C. or greater, about 70° C. or greater, about 80° C. or greater, about 90° C. or greater, about 100° C. or greater, or about 110° C. or greater.

In the lithium recovery process of the present disclosure, the brine source is contacted with a base in a pH elevation step to form a pH-elevated brine. The elevated pH and presence of hydroxyl ions resulting from the added base improves the adsorption kinetics of the subsequent lithium ion adsorption process step as described herein by enhancing proton release from the ion exchange media and making available sites for adsorption of lithium ions.

The base may be any base suitable for elevating the pH of the brine source. In certain embodiments the base can be any strong base. For example, the base may be selected from LiOH, KOH, Zn(OH)₂, RbOH, Ca(OH)₂, and sodium hydroxide (NaOH). In certain embodiments, the base comprises NaOH. The base may have a concentration of about 10.0 wt % to about 50.0 wt %. In certain embodiments, the base has a concentration of about 10.0 wt % to about 15.0 wt %, about 15.0 wt % to about 20.0 wt %, about 20.0 wt % to about 25.0 wt %, about 25.0 wt % to about 30.0 wt %, about 30.0 wt % to about 35.0 wt %, about 35.0 wt % to about 40.0 wt %, about 40.0 wt % to about 45.0 wt %, about 45.0 wt % to about 50.0 wt %.

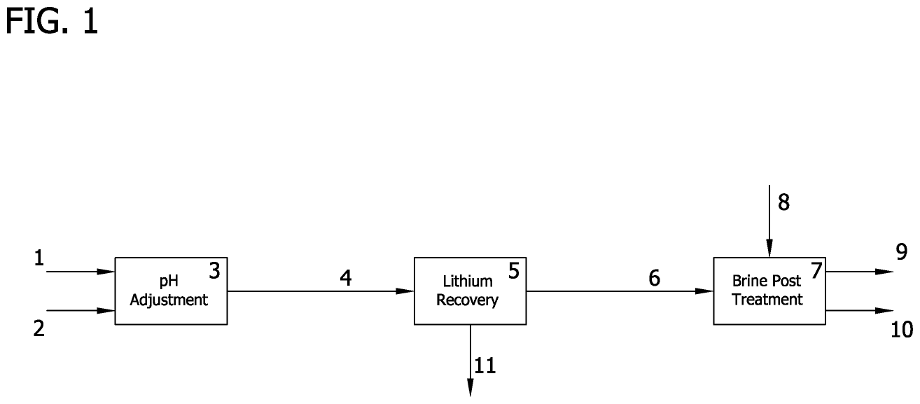

FIG. 1 shows a process flow diagram for the recovery of lithium and post treatment of a brine from which lithium has been removed. In pH elevation step 3, a brine 1 and a source of base 2 are combined to form a pH-elevated brine 4. In certain embodiments, stream 1 is a geothermal brine stream flowing from an upstream facility (e.g., a brine from a geothermal energy production facility) and stream 2 comprises the base (e.g., NaOH).

In certain embodiments, the brine source has a pH from about 3.0 to about 5.5. For example, the brine source can have a pH of about 3.0, about 3.1, about 3.2, about 3.3, about 3.4, about 3.5, about 3.6, about 3.7, about 3.8, about 3.9 about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, and about 5.5. In one embodiment, the brine source has a pH ranging from about 4.2 to about 5.0. Contacting the brine source with the base can result in a pH-elevated brine having a pH ranging from about 5.0 to about 11.0, from about 5.1 to about 11.0, from about 5.2 to about 11.0, from about 5.3 to about 11.0, from about 5.4 to about 11.0, from about 5.5 to about 11.0, from about 5.6 to about 11.0, from about 5.7 to about 11.0, from about 5.8 to about 11.0, from about 5.9 to about 11.0, from about 6.0 to about 11.0, from about 6.1 to about 11.0, from about 6.2 to about 11.0, from about 6.3 to about 11.0, from about 6.4 to about 11.0, from about 6.5 to about 11.0, from about 6.6 to about 11.0, from about 6.7 to about 11.0, from about 6.8 to about 11.0, from about 6.9 to about 11.0, from about 7.0 to about 11.0, from about 7.1 to about 11.0, from about 7.2 to about 11.0, from about 7.3 to about 11.0, from about 7.4 to about 11.0, from about 7.5 to about 11.0, from about 7.6 to about 11.0, from about 7.7 to about 11.0, from about 7.8 to about 11.0, from about 7.9 to about 11.0, from about 8.0 to about 11.0, from about 8.1 to about 11.0, from about 8.2 to about 11.0, from about 8.3 to about 11.0, from about 8.4 to about 11.0, from about 8.5 to about 11.0, from about 8.6 to about 11.0, from about 8.7 to about 11.0, from about 8.8 to about 11.0, from about 8.9 to about 11.0, from about 9.0 to about 11.0, from about 9.1 to about 11.0, from about 9.2 to about 11.0, from about 9.3 to about 11.0, from about 9.4 to about 11.0, from about 9.5 to about 11.0, from about 9.6 to about 11.0, from about 9.7 to about 11.0, from about 9.8 to about 11.0, from about 9.9 to about 11.0, from about 10.0 to about 11.0, from about 10.1 to about 11.0, from about 10.2 to about 11.0, from about 10.3 to about 11.0, from about 10.4 to about 11.0, from about 10.5 to about 11.0, from about 10.6 to about 11.0, from about 10.7 to about 11.0, from about 10.8 to about 11.0, from about 10.9 to about 11.0. Contacting the brine source with the base can result in a pH-elevated brine having a pH ranging from about 5.0 to about 10.5, from about 5.3 to about 10.5, from about 5.5 to about 10.5, from about 5.7 to about 10.5, from about 5.0 to about 10, from about 5.3 to about 10.0, from about 5.5 to about 10, from about 5.7 to about 10, from about 5.0 to about 9.5, from about 5.3 to about 9.5, from about 5.5 to about 9.5, from about 5.7 to about 9.5, from about 5.0 to about 9.0, from about 5.3 to about 9.0, from about 5.5 to about 9.0, from about 5.7 to about 9.0, from about 5.0 to about 8.5, from about 5.3 to about 8.5, from about 5.5 to about 8.5, from about 5.7 to about 8.5, from about 5.0 to about 8.0, from about 5.3 to about 8.0, from about 5.5 to about 8.0, from about 5.7 to about 8.0, from about 5.0 to about 7.5, from about 5.3 to about 7.5, from about 5.5 to about 7.5, from about 5.7 to about 7.5, from about 5.0 to about 7.0, from about 5.3 to about 7.0, from about 5.5 to about 7.0, from about 5.7 to about 7.0, from about 5.0 to about 6.5, from about 5.3 to about 6.5, from about 5.5 to about 6.5, from about 5.7 to about 6.5, from about 5.0 to about 6.0, from about 5.3 to about 6.0, from about 5.5 to about 6.0, from about 5.7 to about 6.0. In another embodiment, the brine source has a pH of about 4.7 and contact with the base results in a pH-elevated brine having a pH of about 7.0 to 8.0.

During a pH elevation step, silica and one or more metal ions may precipitate from the pH-elevated brine. Precipitates may include metal ions from groups, such as alkali metals, transitional metals, and metalloids. What metal ions precipitate will depend on the composition of the brine. Silica and metal ions that precipitate from the pH-elevated brine may include, for example, silica, silicon, iron, manganese, magnesium, zinc, potassium, sodium, calcium, lead, barium, arsenic, boron, strontium, cadmium, chromium, and copper. Metal ions may precipitate from the pH-elevated brine in the form of silicates, metal hydroxides, etc. It will be understood that the particular precipitates that are present in the pH elevation step will depend upon the originating brine source, the base utilized in the pH elevation step, and/or the composition of the pH-elevated brine.

In certain embodiments, the process for increasing the pH of the brine comprises obtaining brine from a brine source comprising lithium ions; adding the brine to a CSTR without preprocessing the brine to remove solid matter; adding a strong base to the CSTR; contacting the brine with the base to form a pH-elevated brine; wherein the pH-elevated brine has a pH of at least about 5.5 or greater, wherein the pH elevation does not create large solids or increase the temperature of the brine.

The processes of the present disclosure allow for the efficient exchange of lithium ions in a pH-elevated brine source even when the pH-elevated brine source comprises appreciable quantities of suspended solids. That is, the present disclosure allows for processing of the pH-elevated brine source without the requirement of a solid/liquid separation process (e.g., filtration) or one or more additional pre-treatment steps (e.g., cooling) before the ion exchange process step. For purposes of the present disclosure, particles having a diameter of greater than about 100.0 microns in diameter are considered large solid particles. In certain embodiments, the pH elevation step of the present process does not comprise large particles, and any solid/liquid separation step(s) would typically not be required. In further embodiments, the solid particle has a diameter less than about 100.0 microns, such as for example less than about 95.0 microns, less than about 90.0 microns, less than about 85.0 microns, less than about 80.0 microns, less than about 75.0 microns, less than about 70.0 microns, less than about 65.0 microns, less than about 60.0 microns, less than about 55.0 microns, less than about 50.0 microns, less than about 45.0 microns, less than about 40.0 microns, less than about 35.0 microns, less than about 30.0 microns, less than about 25.0 microns, less than about 20.0 microns, less than about 15.0 microns, less than about 10.0 microns, or less than about 5.0 microns. In further embodiments, the solid particle has a diameter of less than about 50.0 microns.

Generally, the pH-elevated brine has a solids content similar to or slightly higher than those set forth above with respect to the brine source. In certain embodiments, the pH-elevated brine has a solids content of about 0.1 wt % to about 1.5 wt %. In certain embodiments, the pH-elevated brine has a solids content of about 0.3 wt % or greater, about 0.5 wt % or greater, about 1.0 wt % or greater, about 2.0 wt % or greater, about 3.0 wt % or greater, about 4.0 wt % or greater, about 5.0 wt % or greater, about 6.0 wt % or greater, about 7.0 wt % or greater, about 8.0 wt % or greater, about 9.0 wt % or greater, or about 10.0 wt % or greater. For example, in one embodiment, the brine source is a spent geothermal brine and the pH-elevated brine has a solids content of from about 0.1 wt % to about 10.0 wt %, from about 0.5 wt % to about 10.0 wt %, from about 1.0 wt % to about 10.0 wt %, from about 2.0 wt % to about 10.0 wt %, from about 3.0 wt % to about 10.0 wt %, from about 4.0 wt % to about 10.0 wt %, or from about 5.0 wt % to about 10.0 wt %. In another embodiment, the brine source is a clarifier and/or thickener system overflow stream derived from geothermal operations and the pH-adjusted brine has a solids content of from about 10 ppm to about 2.0 wt %, from about 10 ppm to about 1.0 wt %, from about 100 ppm to about 1.0 wt %, from about 500 ppm to about 1.0 wt %, from about 0.1 wt % to about 1.0 wt %, from about 0.2 wt % to about 1.0 wt %, from about 0.3 wt % to about 1.0 wt %, from about 0.4 wt % to about 1.0 wt %, from about 0.5 wt % to about 1.0 wt %, from about 0.5 wt % to about 0.9 wt %, or from about 0.5 wt % to about 0.8 wt %. It will be understood that, while operable, high percentages of solids content would decrease the efficiency of the methods disclosed in this application. For example, for a solid content of greater than 10.0 wt %, the likelihood of clogging increases within the systems performing these methods. Additional steps may be added to the disclosed methods to overcome these disadvantages, such as adding a solids removal step.

The pH elevation step may be conducted in one or more reactors and/or tanks. The pH elevation reactor(s) may be configured to stir or otherwise agitate the contents of the reactor to reduce solids settling and build up and promote suspension of any precipitated solids. Additional benefits of stirring the contents of each pH elevation reactor are that the brine pH value will be more uniform throughout the tank and contact between hydroxyl ions and ionic components present in the brine is enhanced, thereby reducing the required residence time in the reactor. It is desired that the pH elevation step maintains any present or resulting solids suspended in the brine, such that they are directed to downstream unit operations (e.g., the ion exchange unit operation).

In certain embodiments, one or more of the pH elevation reactors are a CSTR. Each CSTR is sized based on the flow rate of the brine source to be treated to allow for a suitable residence time to achieve the desired pH elevation. In one embodiment, a series of CSTRs and a flow surge tank are used. The CSTRs include one or more impellers or other mixing device such that the pH elevation is substantially uniform throughout the tank and the bulk of any solid precipitates produced are suspended. It is desired that the impellers of the CSTRs or other mixing device(s) present in the reactors are operated to substantially eliminate solids settling and/or any significant precipitate build up in the pH elevation step. That is, the bulk of solids present in the brine source or produced in the pH elevation unit operation remain suspended in the brine and are directed to subsequent unit operations. Operation in this manner not only reduces solids settling/scaling in the pH elevation reactors, but also reduces solids settling/scaling in subsequent process equipment, such as piping.

In one embodiment, the pH elevation step comprises two CSTRs operated in series, each having an impeller or other suitable mixing device therein. In the first pH elevation CSTR, the pH of the brine source is elevated from an initial pH to a first pH-elevated brine having a pH of about 7.0. The first pH-elevated brine is then directed to a second pH elevation CSTR, in which the pH is further elevated to a value of from about 7.0 to about 8.0. In this and other embodiments, the target pH of the pH-elevated brine exiting the pH elevation step leaving the second pH elevation reactor is from about 7.5 to about 8.0. The pH-elevated brine at the target pH may be directed to a surge tank for storage before being forwarded for subsequent processing (e.g., the ion exchange unit operation). In another embodiment, the pH elevation step comprises two CSTRs operated in series, each having an impeller or other suitable mixing device therein. In the first pH elevation CSTR, the pH of the brine source is elevated from an initial pH to a first pH-elevated brine having a pH of about 5.5. The first pH-elevated brine is then directed to a second pH elevation CSTR, in which the pH is further elevated to a value of from about 6.5 to about 7.5. In this and other embodiments, the target pH of the pH-elevated brine exiting the pH elevation step leaving the second pH elevation reactor is from about 7.5 to about 8. The pH-elevated brine at the target pH may be directed to a surge tank for storage before being forwarded for subsequent processing (e.g., the ion exchange unit operation). In yet another embodiment, the pH elevation step comprises three CSTRs operated in series, each having an impeller or other suitable mixing device therein. In the first pH elevation CSTR, the pH of the brine source is elevated from an initial pH to a first pH-elevated brine having a pH of about 6.0. The first pH-elevated brine is then directed to a second pH elevation CSTR, in which the pH is further elevated to a value of from about 6.5 to about 7.0. The second pH-elevated brine is then directed to a third pH elevation CSTR, in which the pH is further elevated to a value of from about 7.0 to about 7.5. In this and other embodiments, the target pH of the pH-elevated brine exiting the pH elevation step leaving the third pH elevation reactor is from about 7.5 to about 8.

The pH-elevated brine is directed to an ion exchange system for extracting lithium ions wherein the pH-elevated brine is contacted with an ion exchange media. The ion exchange media exchanges hydrogen ions (i.e., protons) with lithium ions in the pH-elevated brine to produce a lithiated ion exchange media.

For example, in the embodiment of FIG. 1, the pH-elevated brine 4 is directed to a lithium recovery step 5, comprising an ion exchange process suitable for recovery of lithium ions. In step 5, the pH-elevated brine is contacted with an ion exchange media to selectively adsorb lithium ions and produce a stream 6 having a high percentage of lithium ions removed therefrom that is directed for further processing. The lithium ions are then recovered from the lithiated ion exchange media by contacting the ion exchange media with an acid to form a lithium salt-containing stream 11.

In certain embodiments, the pH-elevated brine remains essentially at the same temperature as the source brine (i.e., it is not subjected to any cooling operation). Typically, the temperature of the pH-elevated brine contacted with the ion exchange media is about 50° C. or greater, about 60° C. or greater, about 70° C. or greater, about 80° C. or greater, about 90° C. or greater, about 100° C. or greater, or about 110° C. or greater.

The ion exchange media comprises a metal oxide adsorbent. The metal oxide may be selected from a manganese oxide, titanium oxide, and mixtures thereof. In one embodiment, the ion exchange media comprises an intercalated lithium metal oxide adsorbent in the form of a molecular sieve.

In certain embodiments, the ion exchange media may further comprise one or more polymeric binder materials in which the metal oxide adsorbent is dispersed or embedded in the form of a bead or pellet for utilization in a fixed or fluidized bed. In one embodiment, the ion exchange media comprises an acrylamide-based polymer binder. In one embodiment, the ion exchange media is in the form of a bead and comprises an intercalated lithium titanium oxide (lithium titanate) adsorbent embedded or dispersed in a porous acrylamide-based polymer. In another embodiment, the ion exchange media comprises a polyvinyl chloride-based polymer binder.

Ion exchange media in the form of a bead typically has a specific gravity of between about 1.0 and about 3.0, between about 1.0 and about 2.5, or between about 1.0 and about 2.0. For example, the ion exchange media may have a specific gravity of about 1.1, about 1.2, about 1.3, about 1.4, about 1.5, about 1.6, or about 1.7. In another embodiment, the ion exchange media has a dry specific gravity between about 0.5 and about 3.0, between about 0.5 and about 2.0, and between about 0.5 and about 1.0. For example, the ion exchange media may have a dry specific gravity of about 0.5, about 0.6, about 0.7, about 0.8, about 0.9, about 1.0, about 1.1, about 1.2, or about 1.3. Further, the ion exchange media in the form of a bead typically has a void ratio of about 35% or greater, about 40% or greater, about 45% or greater, about 50% or greater, about 55% or greater, about 60% or greater, or about 65% or greater. For example, in one embodiment, the ion exchange media has a void ratio of about 56%.

In certain embodiments, the ion exchange particle or bead may be spherical, cylindrical, or randomly shaped. In certain embodiments, the ion exchange particle has a diameter or largest dimension of about 0.5 mm, about 1.0 mm, about 1.5 mm, about 2.0 mm, about 2.5 mm, or about 3.0 mm. In some embodiments, the ion exchange particle is in the form of a bead having a diameter of about 2.0 mm.

In various embodiments, the ion exchange system is operated in a cycle comprising different steps or modes of operation, including lithium adsorption and elution. In certain embodiments, operation of the ion exchange system further includes a cleaning phase to remove entrained solids and/or residual brine from the ion exchange media after lithium adsorption and before elution. For example, in one embodiment, operation of the ion exchange system comprises three distinct modes of operation: lithium adsorption, a wash step, and elution. In another embodiment, operation of the ion exchange system comprises four distinct modes of operation: lithium adsorption, a wash step, a gas purge step, and elution. The ion exchange system may be operated such that the steps of the cycle are conducted in a batch, semi-batch, and/or continuous manner. In certain embodiments, the ion exchange system processes pH-elevated brine continuously. For example, in one embodiment, the ion exchange system comprises a plurality of vessels, each containing a bed of the ion exchange media. The plurality of vessels are in selective fluid communication with a supply of pH-elevated brine, wash liquid, purge gas, and/or an elution liquid comprising an acid and each step of the cycle (e.g., the lithium ion adsorption, wash step, gas purge step, and/or elution) is conducted serially in each of the vessels in offset cycles. Furthermore, in certain embodiments of the ion exchange system, each distinct mode of operation may be conducted simultaneously in two or more vessels operating in series or parallel.

In one embodiment, each vessel of the ion exchange system comprises one or more upper screen and lower screen, with the ion exchange media disposed between the upper and lower screens. The upper and lower screens define the upper and lower bounds of the bed comprising the ion exchange media that may be configured and operated as a fixed, fluidized, or expanded bed. The openings in the upper and lower screens are sized such that the brine and suspended solids or other particles present within the brine may pass through the openings in the screens, but the ion exchange media is substantially retained between the screens. For example, the openings defined by the screen(s) may have a largest dimension of about 2.5 mm or less, about 2.3 mm or less, about 2.0 mm or less, about 1.9 mm or less, about 1.8 mm or less, about 1.7 mm or less, about 1.6 mm or less, about 1.5 mm or less, about 1.4 mm or less, about 1.3 mm or less, about 1.2 mm or less, about 1.1 mm or less, about 1.0 mm or less, about 0.9 mm or less, about 0.8 mm or less, about 0.7 mm or less, about 0.6 mm or less, or about 0.5 mm or less. It will be understood that in operation, a negligible amount of media may pass through the openings in the screen and the bed volume may be replenished as needed by addition of additional ion exchange material.

In another embodiment, one or more vessels of the ion exchange system comprise a lower screen and no upper screen. In this embodiment, the superficial velocity of the inlet stream is controlled such that larger denser media is largely prevented from exiting the ion exchange vessel, while finer or less dense solid precipitates are allowed to flow out of the vessel with the lithium-depleted brine.

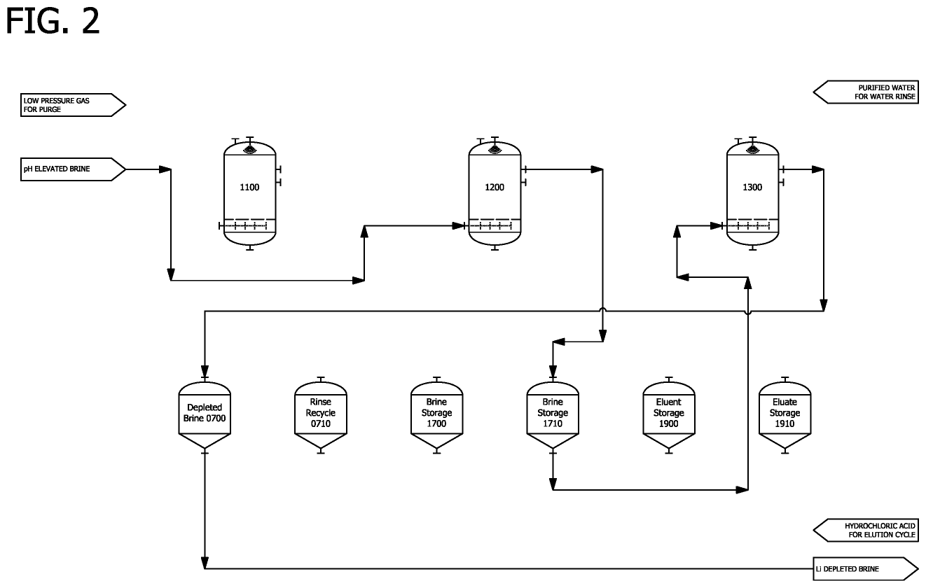

Further, each vessel of the ion exchange system includes fluid inlets in selective fluid communication with a supply of pH-elevated brine, wash liquid, purge gas, and an elution liquid and fluid outlets for removing various process streams after passage through the bed of ion exchange material as will be described in detail below. As shown in FIGS. 2-7, inlets for the supply of pH-elevated brine and wash liquid are provided adjacent to the lower portion of each vessel below the screen defining the bottom of the ion exchange bed and inlets for the supply of purified water, purge gas and elution liquid are provided adjacent to the upper end of each vessel at an elevation above the bed of ion exchange media.

In one embodiment, the ion exchange system is configured such that the media bed within each vessel is capable of being fluidized by the various process streams (e.g., pH-elevated brine and wash liquid) introduced into the vessel below the lower screen and contacted with the ion exchange media. In certain other embodiments, one or more of the vessels may be a CSTR, which fluidizes the media bed by operation of the impeller or other mixing device within the CSTR. Fluidization of the media bed during the adsorption step promotes contact between the lithium-rich brine and the ion exchange media and improves adsorption efficiency. Likewise, fluidization during the wash step improves the efficiency of removing entrained solids from the bed of ion exchange material.

In certain embodiments, one or more of the vessels of the ion exchange system may comprise additional filters or screens at the fluid inlet(s) and/or outlet(s) of the vessel, to retain the ion exchange media within the vessel. In some embodiments, the vessels, screen(s) and/or filter(s) comprises metal, polymeric material, or ceramic material and are selected to be suitable for contact with the liquids and/or solids present in the system. For example, the metal may be selected from stainless steel, titanium, HASTELLOY alloys, and combinations thereof. For example, the metal may be a selected from 2205 or 2207 duplex stainless steel.

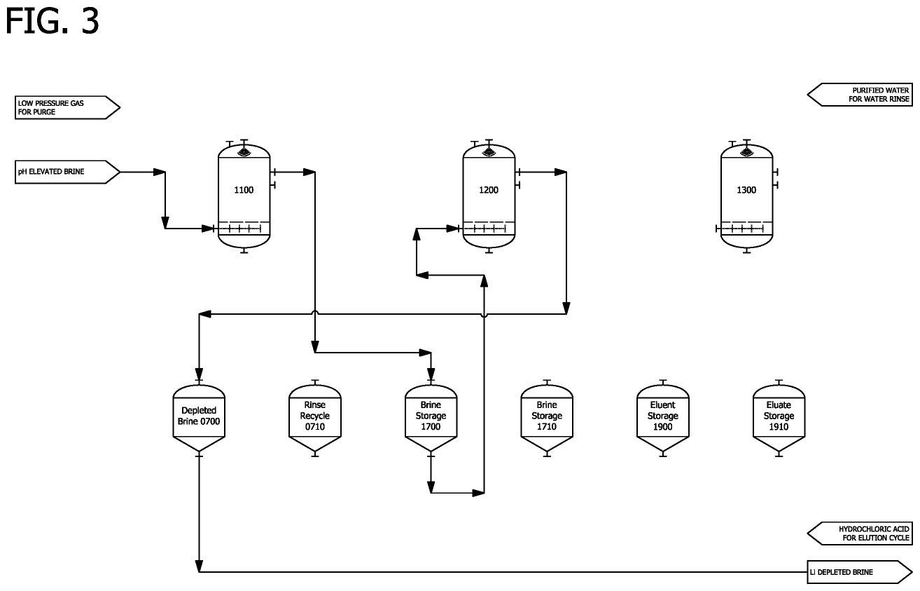

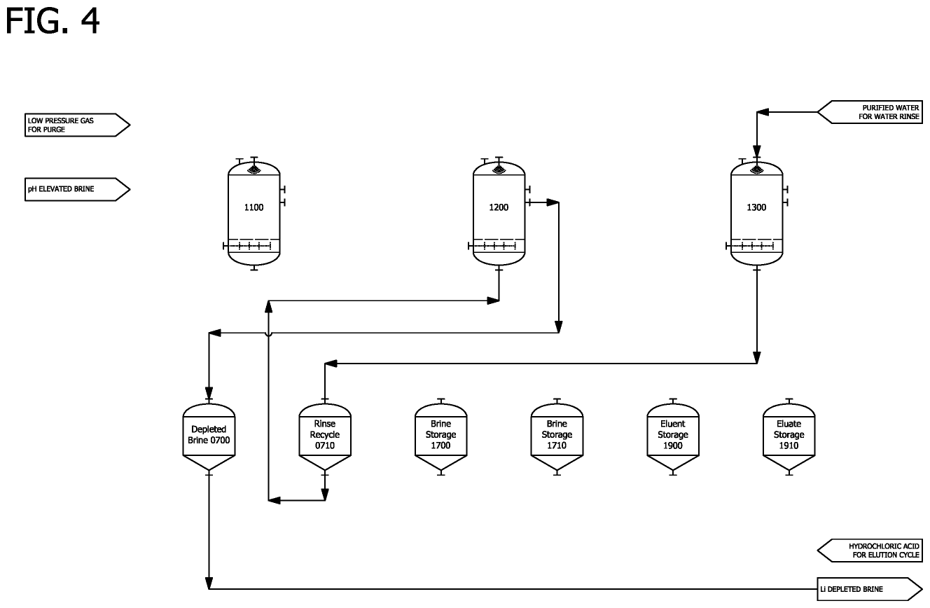

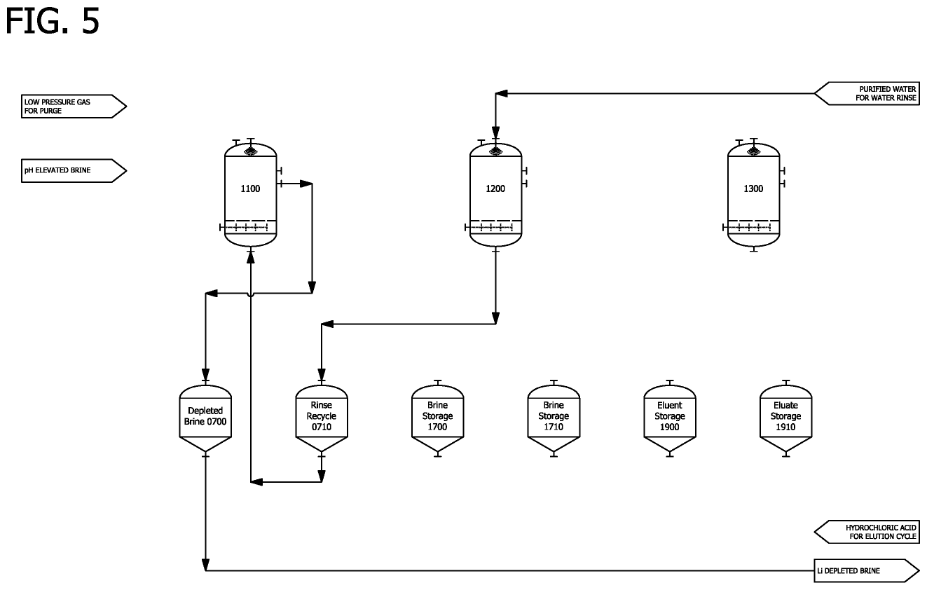

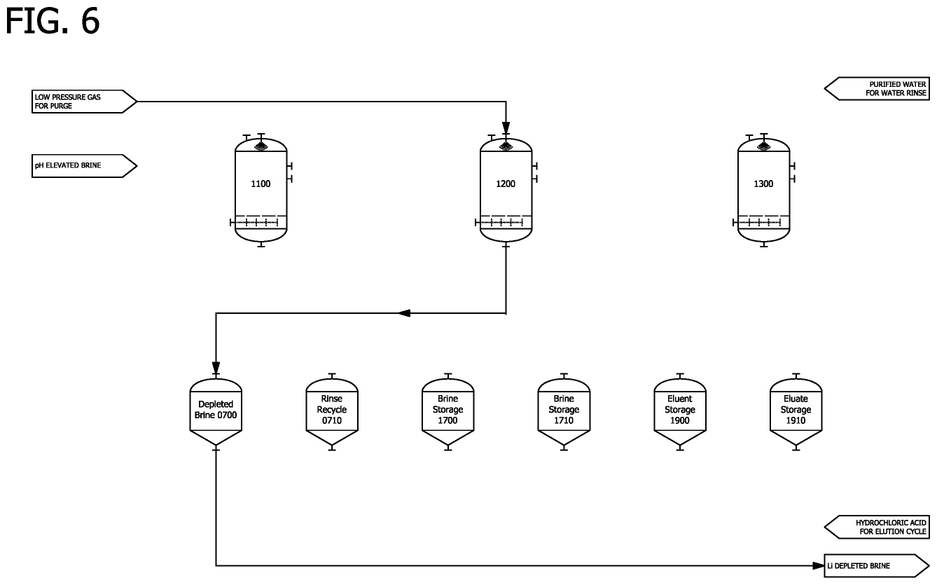

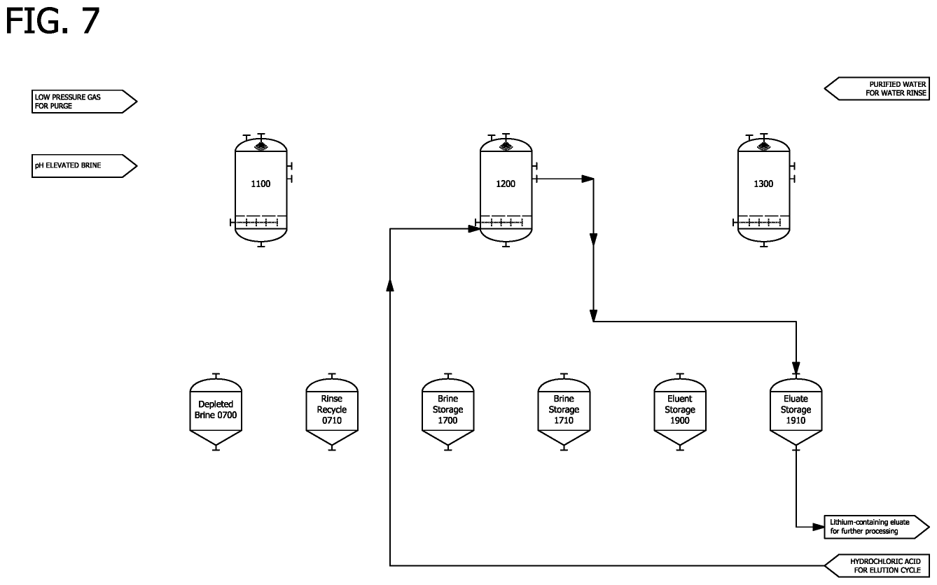

In one embodiment, the ion exchange system 5 is represented by the process flow schemes set forth in FIGS. 2-7. In this exemplary embodiment, the ion exchange system includes four distinct modes of operation: lithium adsorption, a wash step, a gas purge step, and elution. FIGS. 2 and 3 illustrate multiple vessels 1200/1300 and 1100/1200, respectively, operating in lithium adsorption mode. FIGS. 4 and 5 illustrate multiple vessels 1200/1300 and 1100/1200, respectively, operating in wash mode. FIG. 6 illustrates vessel 1200 operating in gas purge mode and FIG. 7 represents vessel 1200 operating in elution mode. It should be understood that these figures represent isolated moments in time and as described herein each of the vessels are operated serially in accordance with the four modes of operation (lithium adsorption, a wash step, a gas purge step, and elution) in offset cycles.

Additionally, as shown in FIGS. 2-7, the ion exchange system may further comprise one or more surge tanks in selective fluid communication with the ion exchange vessels to serve as input locations for additional components (e.g., the acid for elution) and/or buffering the volumetric flow of various process streams through the ion exchange system.

During the lithium adsorption mode or lithium ion exchange step of the ion exchange cycle, the pH-elevated brine is contacted with protonated ion exchange media in one of more of the ion exchange vessels. The protonated ion exchange media exchanges hydrogen ions with lithium ions in the pH-elevated brine to produce a lithiated ion exchange media and a brine depleted in lithium ions. As the hydrogen ions present in the ion exchange media exchange with the lithium ions present in the pH-elevated brine, the pH of the brine within the ion exchange vessel decreases due to the increased concentration of protons. As the pH decreases, the adsorption kinetics of the ion exchange process decreases. In accordance with the present disclosure, by contacting a pH-elevated brine with the protonated ion exchange media in the lithium ion adsorption step, initial exchange of hydrogen ions and lithium ions is enhanced.

In order to counteract the acidification of the brine during the course of lithium ion adsorption, in certain embodiments, additional base is added to the one or more ion exchange vessels to maintain the elevated pH of the brine contacted with the ion exchange media. In another embodiment, additional base is added to one or more surge tanks before the one or more adsorption vessels to maintain the elevated pH of the brine throughout the respective adsorption vessel. In a still further embodiment, additional base is added to a pipe connecting the one or more surge tanks and the one or more adsorption vessels. The addition of base allows the ion exchange media to selectively adsorb the lithium ions for a longer period of time by capitalizing on the improved adsorption kinetics of contact with a pH-elevated brine. In this embodiment, as the adsorption capacity of the ion exchange media is approached, the pH of the stream exiting the adsorption vessel will increase above the desired set point of the inlet pH-elevated brine. This increase in pH is caused by the continued addition of base and simultaneous slowing of the proton release from the ion exchange media. The increase in pH of the exit stream may be used to evaluate the endpoint of the adsorption step.

FIGS. 2 and 3 illustrate an exemplary process for the adsorption step of the ion exchange system wherein the process comprises three vessels and two vessels operating in series in a first (primary) and second (finishing) lithium adsorption step, respectively. In this embodiment, each vessel is subjected to a first and second adsorption step. The primary lithium adsorption step is conducted in the leading vessel wherein the pH-elevated brine is contacted with a partially lithiated bed of ion exchange media and the finishing lithium adsorption step is conducted in the lagging vessel wherein a partially lithium-depleted brine is contacted with a fully protonated bed of ion exchange media. By contacting the pH-elevated brine containing the highest concentration of lithium, the adsorption capacity of the ion exchange media in the leading vessel is more fully utilized. By contacting the partially lithium-depleted brine with fully protonated ion exchange media in the lagging vessel, the ion exchange media is able to more quickly and fully adsorb the remaining lithium ions from the lower concentration brine.

In Step 1A (i.e., FIG. 2), the pH-elevated brine is directed to leading vessel 1200, operating in a primary lithium adsorption mode and then to lagging vessel 1300, operating in a finishing lithium adsorption mode. Vessel 1200 contains a bed of partially protonated ion exchange media for the selective recovery of lithium ions. The pH-elevated brine is introduced into the bottom of the vessel as shown in FIG. 2. The superficial velocity of the inlet pH-elevated brine stream is such that the ion exchange media is fluidized within the media bed. When the pH-elevated brine contacts the partially lithiated ion exchange media, the ion exchange media exchanges hydrogen ions with lithium ions present in the pH-elevated brine to produce a lithiated ion exchange media.

The outlet of vessel 1200 (i.e., a partially lithium-depleted brine) is directed to brine storage tank 1710. The partially lithium-depleted brine from tank 1710 is then introduced into the bottom of lagging vessel 1300 as shown in FIG. 2. Vessel 1300 contains a bed of fully protonated ion exchange media for the selective recovery of lithium ions. The superficial velocity of the inlet lithium-depleted brine is such that the ion exchange media is fluidized within the media bed. From the outlet of vessel 1300, the brine further depleted in lithium ions, is directed to tank 0700 and then for further processing and/or reinjection into the geothermal well.

The pH-elevated brine entering vessel 1200 is at an elevated pH after pH elevation with a source of base. However, when the protons of the ion exchange media exchange with the lithium ions present in the pH-elevated brine, the pH of the brine decreases due to the increased concentration of protons. During adsorption, the pH of the stream exiting vessel 1200 will be lower than the pH of the inlet stream. As the adsorption capacity of the ion exchange media is approached, fewer protons will be released into the brine, and a sharp decrease in pH between the inlet and outlet streams will no longer be observed. When the pH of the stream exiting vessel 1200 approaches or exceeds the elevated pH of the inlet stream, it can be assumed that adsorption is no longer taking place (i.e., hydrogen ions are no longer being exchanged with the lithium ions of the brine) and the adsorption capacity of the ion exchange media has been reached. A similar relationship can be evaluated in vessel 1300.

In FIG. 2, the outlet pH of the lithium adsorption Step 1A can be evaluated and an end point can be determined based on the relation of the exit pH to the pH of the pH-elevated brine entering the lithium adsorption step. For example, an “end point” of the lithium adsorption Step 1A can be determined by comparing 1) the pH of the pH-elevated brine to the pH of the partially lithium-depleted brine exiting vessel 1200; 2) the pH of the pH-elevated brine to the pH of the brine further depleted in lithium ions exiting vessel 1300; 3) the pH of the partially lithium-depleted brine exiting vessel 1200 to the pH of the brine further depleted in lithium ions exiting vessel 1300; or any combination thereof.

In certain embodiments, Step 1A of the lithium adsorption step is operated for a period of at least about 5 minutes, at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, or at least about 1 hour (60 minutes). In one embodiment, the lithium adsorption Step 1A is operated for a period of about 40 minutes.

Lithium adsorption Step 1B is illustrated in FIG. 3 and is conducted to ensure the adsorption capacity of an ion exchange vessel is utilized to the best of its potential before elution. Step 1B operates in much the same manner as Step 1A, except that vessel 1100 is the leading vessel operating in the first (primary) lithium adsorption mode and vessel 1200 is the lagging vessel operating in the second (finishing) lithium adsorption mode. The end point and residence time of the lithium adsorption Step 1B can be determined as described above with respect to Step 1A.

A multi-vessel, two-step process of adsorption ensures that the lithium present with the pH-adjusted brine has multiple opportunities to be selectively adsorbed by the ion exchange media and results in greater recovery of the desired lithium ions. For example, in this Step 1A/Step 1B configuration, the pH elevated brine is contacted with a partially lithiated media bed (e.g., leading vessel 1200 in FIG. 2) to remove a majority of the lithium ions. The partially depleted brine is then contacted with a fully protonated media bed (e.g., lagging vessel 1300 in FIG. 2) to ensure faster and/or more complete adsorption of the remaining lithium ions. At the conclusion of lithium adsorption Step 1A and 1B, as illustrated in FIGS. 2 and 3, vessel 1200 contains a lithiated ion exchange media suitable for elution. In certain embodiments, the ion exchange media absorbs greater than 95% of the lithium ions present in the pH-elevated brine. In other embodiments, the ion exchange media absorbs greater than 95%, greater than 90%, greater than 85%, greater than 80%, greater than 75%, greater than 70%, greater than 65%, greater than 60%, greater than 55%, greater than 50%, greater than 45%, greater than 40%, greater than 35%, greater than 30%, greater than 25%, greater than 20%, greater than 15%, greater than 10% of the lithium ions present in the pH-elevated brine.

In certain embodiments, base is added to vessel 1100 and/or 1200 in steps 1A and/or 1B. In another embodiment, base is added to the pH elevated brine and/or partially lithium-depleted brine in steps 1A and/or 1B. In these embodiments, the pH exiting the respective vessel will increase above the desired set point of the inlet pH-elevated brine as the adsorption capacity of the ion exchange media is reached. This increase in pH is caused by the continued addition of base and a simultaneous slowing of the proton release from the ion exchange media. Alternately, the process may be designed such that the addition of base is proportionally decreased as the proton release from the ion exchange media slows. In this embodiment, the adsorption capacity of the ion exchange media is reached as the amount of added base approaches zero.

In the wash step mode of the process, the lithiated ion exchange media is contacted with an acidic aqueous wash liquid to remove impurities and solid precipitates and produce a washed lithiated ion exchange media.

At the conclusion of the adsorption step, the ion exchange media bed may still contain at least a portion of the brine retained by the ion exchange media. Without being bound by the theory, it is believed that a certain amount of liquid from the brine adheres to the surface of the media or is otherwise entrained within the interstitial spaces in the media bed by surface tension. If brine liquids are allowed to be retained in and on the media, the entrained brine would cause contamination of the final lithium salt product. That is, without further processing, the final lithium salt product solution would contain a high mineral content partially attributable to entrained brine fluid within the media bed or on the surface of the vessel. To the extent that brine fluid is retained by the ion exchange media, it may be desirable to remove at least a portion of the brine fluid. To remove this retained brine fluid, the ion exchange media is subjected to a wash step to dilute and/or displace entrained brine with an acidic aqueous wash liquid. Use of a wash step may further remove other contaminants present on the process equipment (e.g., walls of the vessel), resulting in a less contaminated product stream. Without being bound to the theory, it is believed that the lower pH of the acidic aqueous wash liquid allows for any solids that are removed to at least partially dissolve in the wash liquid and be more easily processed when exiting the wash step.

The acidic aqueous wash liquid in the wash step may be any acidic aqueous wash liquid that is suitable for displacing or diluting the brine fluid retained by the ion exchange media.

In one embodiment, the acidic aqueous wash liquid comprises deionized water, reverse osmosis water, reclaimed water from another location in the process, liquid having a pH of below about 7.0, or combinations thereof. In certain embodiments, the acidic aqueous wash liquid comprises deionized water. In other embodiments, the acidic aqueous wash liquid comprises reverse osmosis water.

In another embodiment, the acidic aqueous wash liquid comprises brine. The brine may be the same or different as the brine source introduced into the pH adjustment step described above. For example, the wash brine may be selected from geothermal brine, spent brine, post-clarifier/thickener brine, lithium-depleted brine, or lithium-depleted acid adjusted brine.

The acidic aqueous wash may be prepared by the addition of a suitable acid (e.g., HCl) to deionized water or other source of water used in the wash step, as necessary, to attain the desired pH. The pH of the acidic aqueous wash is typically from about 4.0 to about 6.5, such as from about 4.0 to about 6.0, from about 4.5 to about 6.0, and from about 4.5 to about 5.5.

The wash step results in a washed lithiated ion exchange media from which solids and/or lithium-depleted brine fluid have been removed and a wash exit stream containing the entrained brine fluid and/or solids.

The wash step exit stream comprising the brine fluid may be disposed of or processed and/or recycled as a source of wash liquid for the wash step. For example, the wash exit stream may be processed by evaporation, filtration, reverse osmosis, ion exchange or combinations thereof to prepare a processed wash exit stream that is suitable for forming at least a portion of the acidic aqueous wash liquid of the wash step. In certain embodiments, at least a portion of the stream exiting the wash step (i.e., a slip stream) may be recycled and combined with the brine source prior to the pH elevation step and further processing as described above.

In one embodiment, the acidic aqueous wash liquid may be introduced into the bottom of the vessel, thereby filling the media bed and overflowing out one of the side ports of the vessel. In another embodiment, the acidic aqueous wash liquid may be introduced in the top of the vessel. In this embodiment, the acidic aqueous wash liquid may be allowed to accumulate until a volume equal to at least one media bed volume, or less, has entered the vessel. The acidic aqueous wash liquid is then allowed to drain from the vessel while additional acidic aqueous wash liquid enters the vessel. The wash step may be conducted until the desired amount of acidic aqueous wash liquid has been introduced and drained from the vessel (e.g., a volume equal to at least about two media bed volumes).

In another embodiment, the wash step may comprise two or more vessels simultaneously operating in the wash step mode, wherein the vessels operating in wash step mode are subjected to two wash liquids. In this embodiment, an acidic aqueous wash liquid is introduced into a first wash vessel and the exit stream comprising brine fluid is then directed to a second wash vessel in the form of a “recycle wash liquid,” as a source of acidic aqueous wash liquid for the second wash vessel. For example, in one embodiment, the wash step comprises contacting the lithiated ion exchange media with a first acidic aqueous wash liquid comprising recycle wash liquid to fluidize the bed of lithiated ion exchange media and form an intermediate washed lithiated ion exchange media and an impurity-containing wash stream and contacting the intermediate washed lithiated ion exchange media with a second acidic aqueous wash liquid to form the washed lithiated ion exchange media and the recycle wash liquid. This configuration is shown, for example, in FIGS. 4 and 5. In another embodiment, the first and second acidic aqueous wash are both introduced into the vessels at the top of the vessel. In some embodiments, the acidic aqueous wash liquid may comprise deionized water. The pH of the recycle wash liquid may be higher than the pH of the second aqueous acidic wash liquid. The pH of the second aqueous acidic wash liquid may be, for example, from about 4.0 to about 6.5, from about 4.0 to about 6.0, from about 4.5 to about 6.0, or from about 4.5 to about 5.5.

In the wash Step 2A (FIG. 4), an acidic aqueous wash liquid (e.g., comprising deionized water) is introduced into the top of vessel 1300 to remove retained brine fluid and/or solids. The resulting exit wash stream is directed to tank 0710 and is then pumped as a “recycle wash liquid” to the bottom of vessel 1200 in order to fluidize the bed. The stream exiting vessel 1200 is sent to tank 0700 and may then be directed for further processing and/or reinjection into the geothermal well. In the wash Step 2B (FIG. 5), an acidic aqueous wash liquid is introduced into the top of vessel 1200 to remove retained brine fluid and/or solids. The resulting exit wash stream is directed to tank 0710 and is then pumped as a “recycle wash liquid” to the bottom of vessel 1100 to fluidize the bed. The stream exiting vessel 1100 is sent to tank 0700 and may then be directed for further processing and/or reinjection into the geothermal well.

By subjecting vessel 1200 to a recycle wash liquid and then an acidic aqueous wash liquid, the lithiated ion exchange media is washed in a more economical and complete manner. In wash step 2A, the lithiated ion exchange media in vessel 1200 is contacted with a recycle wash liquid that may have retained brine fluid and/or solids from vessel 1300. This recycle wash liquid is pumped to the bottom of the vessel such that the media bed is fluidized. By fluidizing the bed and subjecting the lithiated ion exchange media to a less pure (i.e., recycle) wash liquid, wash step 2A allows the removal of any large solids or components of brine fluid present on the media without requiring the cost of a pure wash liquid. Then, when a fresh source of acidic aqueous wash liquid is introduced into the top of vessel 1200 in Step 2B, the fresh wash liquid is able to remove and/or dilute any additional retained brine fluid and/or solids. By operating in this two-step wash configuration, the capital costs are reduced and the washed lithiated ion exchange media resulting from Step 2B has fewer contaminants or undesirable components than if the wash step was conducted in a single pass.

In certain embodiment, a suitable wash period for the wash step may be determined based on a comparison of the inlet acidic aqueous wash liquid to the wash exit stream. For example, a comparison of the solids concentration, pH, etc. In one embodiment, the solids content of the acidic aqueous wash liquid entering the wash step can be measured and compared to the solids contained in the stream exiting the wash step. As accumulated solids are removed from the ion exchange media, the solids content of the exit stream will exceed the solids content of the inlet stream. When the accumulated solids content of the outlet stream approaches that of the inlet stream, it can be assumed that the majority of the accumulated solids have been removed from the ion exchange media. In one embodiment, a turbidity meter is used to evaluate the solids content. This information, in combination with commercial considerations, can be used to determine a suitable end point of the wash step(s).

In the gas purge step of the ion exchange process, the washed lithiated ion exchange material is contacted with a purge gas to force liquid entrained within the bed of washed lithiated ion exchange media from the bed. The gas purge step produces a purged washed lithiated ion exchange media having fewer contaminants (i.e., residual brine and/or solids) and less extraneous fluids.

Without being bound to the theory, it is believed that contacting the ion exchange media with steam or an inert gas, particularly following contact with an aqueous wash liquid, facilitates removal of entrained fluids by forcing the liquid, and associated dissolved or suspended solids, off of the media, from interstitial spaces within the bed, and potentially out of the porous structure of the ion exchange media.

To prevent corrosion or other undesirable effects in downstream process equipment, the purge gas is any gas that is inert or essentially free of oxygen. For example, the purge gas may be selected from nitrogen, argon, steam, and combinations thereof. In certain embodiments, the purge gas comprises steam. In some embodiments, the purge gas comprises nitrogen.

In FIG. 6, low pressure (i.e., less than 10 psia) steam is introduced into the top of vessel 1200 and forces liquid entrained within the bed of washed lithiated ion exchange media from the bed, resulting in a purged washed lithiated ion exchange media. The stream containing the entrained liquid and/or solids from the ion exchange media is directed to tank 0700 and may then be directed for further processing and/or reinjection into the geothermal well.

In the elution mode of the ion exchange process, the purged washed lithiated ion exchange media is contacted with an elution liquid comprising an acid. The purged washed lithiated ion exchange media prior to elution contains the selectively recovered lithium ions from the pH-elevated brine and has a reduced amount of undesirable constituents, such as solids and entrained brine fluid.

Hydrogen ions from the elution liquid comprising an acid exchange with the lithium ions present in the ion exchange media to produce a lithium salt solution product stream and an ion exchange material having lithium ions removed therefrom. At the conclusion of the elution step, sufficient lithium ions will have been removed from the ion exchange material such that the media is “regenerated” (i.e., protonated) and in a condition to be able to adsorb further lithium ions (e.g., in the lithium adsorption mode).

The elution liquid may be introduced at the top or bottom of the vessel. In one embodiment, the elution liquid is introduced at the top of the vessel. In another embodiment, the elution liquid is introduced at the bottom of the vessel. In certain embodiments, the elution liquid is introduced at a sufficient superficial velocity to fluidize the media bed.

The acid may comprise any suitable acid for the exchange of lithium ions. For example, the acid may comprise a mineral acid selected from nitric acid, sulfuric acid, phosphoric acid, boric acid, hydrofluoric acid, hydrobromic acid, perchloric acid, hydriodic acid, hydrochloric acid, and combinations thereof. In one embodiment, the acid comprises hydrochloric acid. Wherein the acid comprises hydrochloric acid, the resulting lithium salt stream comprises lithium chloride. In certain embodiments, the elution liquid comprising an acid has a pH of about 2.0 or lower, about 1.5 or lower, about 1.0 or lower, or about 0.5 or lower.

When the hydrogen ions (i.e., protons) of the acid exchange with the lithium ions present in the lithiated ion exchange media, the pH of the stream within the vessel increases due to the decreased concentration of protons. As the exchange of protons and lithium slows, the pH of the stream exiting the elution step will decrease, approaching the pH of the inlet elution stream. Therefore, a suitable operation time for the elution step may be determined based on evaluation of the pH of the inlet acid stream and outlet lithium salt product stream. This information, in combination with commercial considerations, can be used to determine a suitable end point of the elution step.

In FIG. 7, the elution liquid comprising hydrochloric acid is directed to the bottom of vessel 1200 at a sufficient superficial velocity to fluidize the media bed. The contact with hydrochloric acid results in an ion exchange media that is “regenerated” (i.e., protonated) and an eluate exit stream (i.e., lithium salt solution product stream) that is directed to tank 1910. The lithium salt solution product stream may be recovered as a final lithium salt product or directed for further processing as described herein. In one embodiment, the lithium salt product stream is processed to prepare a higher purity lithium salt product. In another embodiment, the lithium salt product stream is converted to a lithium hydroxide product through electrolysis.

In certain alternative embodiments (not shown in FIG. 7), the elution liquid comprising an acid is contacted with the lithiated ion exchange media in a recirculation loop configuration. In this embodiment, a stream comprising an elution liquid comprising an acid is introduced into the elution vessel (e.g., at the bottom of the vessel) and a stream comprising lithium salt overflows from the elution vessel (e.g., at a side port above the elevation of the top of the bed of ion exchange media). The stream comprising lithium salt flows from the elution vessel, is optionally directed to a surge tank, and is then reintroduced into the elution tank as a source of elution liquid, thereby forming a recirculation loop. During recirculation, additional elution liquid comprising an acid may be added to the stream entering the elution vessel. The recirculation loop, and optional addition of elution liquid, may be repeated until a desired concentration of lithium salt is present in the elution vessel exit stream and/or surge tank. At this point, a slip stream may be withdrawn from the elution vessel exit stream and/or surge tank as the lithium salt product stream and recovered or processed as described herein.

In certain embodiments, the elution step has an operation time of at least about 5 minutes, such as, for example, at least about 10 minutes, at least about 15 minutes, at least about 20 minutes, at least about 25 minutes, at least about 30 minutes, at least about 35 minutes, at least about 40 minutes, at least about 45 minutes, and at least about 50 minutes. In one embodiment, the elution step has a residence time of about 35 minutes. In a further embodiment, the elution step has a residence time of about 30 minutes.

The lithium recovery of the ion exchange process is designed to recover a commercially acceptable amount of lithium from the brine source. For example, at least about 50% lithium on a mass basis was recovered from the brine source. In certain embodiments, the amount of lithium recovered from the brine source was at least about 60% on a mass basis, such as, for example, at least about 70%, at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% on a mass basis.

Optionally, a water wash step and/or gas purge step can be conducted after contact with the elution liquid comprising an acid and prior to the adsorption step. The water wash step or gas purge step may comprise the introduction of an aqueous wash liquid and/or an inert gas. In one embodiment, after contact with the elution liquid comprising an acid, the process comprises a water wash step followed by a gas purge step. The stream resulting from this water wash step/additional purge step can be combined with the elution stream and directed as a single lithium salt solution stream for further processing as described herein. Such an optional water wash and/or purge step may enhance the adsorption of lithium in the subsequent adsorption step by removal of acidic liquid from the bed of ion exchange material. Removal of acidic liquid will allow for the benefits of pH-adjusted brine adsorption discussed above to be more fully realized.

As discussed above, it should be understood that FIGS. 2-7 represent isolated moments in time during the ion exchange process. For example, although FIG. 7 shows vessel 1200 operating in elution mode, at various points in time vessels 1100 and/or 1300 are also operated in elution mode. Set forth below are tables illustrating, in a three-vessel system of FIGS. 2-7, the ion exchange cycle in each vessel. These tables are in no way intended to limit the ion exchange process and are provided only for purposes of demonstrating how each vessel changes its “mode” of operation during a semi-continuous or continuous ion exchange process. As noted above, the ordering of the ion exchange process may be changed and/or additional wash step(s) or purge step(s) may be utilized throughout the process.

TABLE 1
Ion Exchange Cycle of Vessel 1100

| Step | Vessel 1100 | Vessel 1200 | Vessel 1300 |
|---|---|---|---|
| 1 | Mode: Adsorption | Mode: Adsorption | |
| | Inlet Stream: pH- | Inlet Stream: | |
| | elevated brine | Partially lithium- | |
| | | depleted brine | |
| 2 | Mode: Adsorption | | Mode: Adsorption |
| | Inlet Stream: | | Inlet Stream: pH- |
| | Partially lithium- | | elevated brine |
| | depleted brine | | |
| 3 | Mode: Wash step | Mode: Wash step | |
| | Inlet Stream: | Inlet Stream: | |
| | Recycle wash liquid | Pure wash liquid | |
| 4 | Mode: Wash step | | Mode: Wash step |
| | Inlet Stream: | | Inlet Stream: |
| | Pure wash liquid | | Recycle wash liquid |
| 5 | Mode: Purge step | | |
| | Inlet Stream: Steam | | |
| 6 | Mode: Elution | | |
| | Inlet Stream: | | |
| | Hydrochloric acid | | |
| 1 | Mode: Adsorption | Mode: Adsorption | |
| | Inlet Stream: pH- | Inlet Stream: | |
| | elevated brine | Partially lithium- | |
| | | depleted brine | |

TABLE 2
Ion Exchange Cycle of Vessel 1200

| Step | Vessel 1100 | Vessel 1200 | Vessel 1300 |
|---|---|---|---|
| 1 | | Mode: Adsorption | Mode: Adsorption |
| | | Inlet Stream: pH- | Inlet Stream: |
| | | elevated brine | Partially lithium- |
| | | | depleted brine |
| 2 | Mode: Adsorption | Mode: Adsorption | |
| | Inlet Stream: pH- | Inlet Stream: | |
| | elevated brine | Partially lithium- | |
| | | depleted brine | |
| 3 | | Mode: Wash step | Mode: Wash step |
| | | Inlet Stream: | Inlet Stream: |
| | | Recycle wash liquid | Pure wash liquid |
| 4 | Mode: Wash step | Mode: Wash step | |
| | Inlet Stream: | Inlet Stream: | |
| | Recycle wash liquid | Pure wash liquid | |
| 5 | | Mode: Purge step | |
| | | Inlet Stream: Steam | |
| 6 | | Mode: Elution | |
| | | Inlet Stream: | |
| | | Hydrochloric acid | |
| 1 | | Mode: Adsorption | Mode: Adsorption |
| | | Inlet Stream: pH- | Inlet Stream: |
| | | elevated brine | Partially lithium- |
| | | | depleted brine |

TABLE 3
Ion Exchange Cycle of Vessel 1300

| Step | Vessel 1100 | Vessel 1200 | Vessel 1300 |
|---|---|---|---|
| 1 | Mode: Adsorption | | Mode: Adsorption |
| | Inlet Stream: | | Inlet Stream: pH- |
| | Partially lithium- | | Elevated Brine |
| | depleted brine | | |
| 2 | | Mode: Adsorption | Mode: Adsorption |
| | | Inlet Stream: pH- | Inlet Stream: |
| | | elevated brine | Partially lithium- |
| | | | depleted brine |
| 3 | Mode: Wash step | | Mode: Wash step |
| | Inlet Stream: | | Inlet Stream: |
| | Pure wash liquid | | Recycle wash liquid |
| 4 | | Mode: Wash step | Mode: Wash step |
| | | Inlet Stream: | Inlet Stream: |
| | | Recycle wash liquid | Pure wash liquid |
| 5 | | | Mode: Purge step |
| | | | Inlet Stream: Steam |
| 6 | | | Mode: Elution |
| | | | Inlet Stream: |
| | | | Hydrochloric acid |
| 1 | Mode: Adsorption | | Mode: Adsorption |
| | Inlet Stream: | | Inlet Stream: pH- |
| | Partially lithium- | | elevated brine |
| | depleted brine | | |

Although the ion exchange system is described above as comprising four distinct modes of operation (lithium adsorption, wash step, purge step, and elution) in a particular order, it will be understood that the wash step and purge step modes of operation may be reordered and/or eliminated. That is, one or more additional wash steps or purge steps may be utilized in the ion exchange system. For example, in one embodiment, the ion exchange system may be operated in the order: lithium adsorption, wash step, gas purge step, elution, wash step. In another embodiment, the ion exchange system may be operated in the order: lithium adsorption, wash step, gas purge step, wash step, elution. In still a further embodiment, the ion exchange system may be operated in the order: lithium adsorption, wash step, gas purge step, elution, wash step, gas purge step. In further embodiments, the ion exchange system does not comprise a gas purge step. For example, in one embodiment, the ion exchange system may be operated in the order: lithium adsorption, wash step, elution. In another embodiment, the ion exchange system may be operated in the order: lithium adsorption, wash step, elution, wash step.

In certain embodiments, the stream exiting the lithium adsorption step of the lithium ion exchange process, i.e., a pH-elevated brine having lithium removed therefrom, may be directed for post treatment. In some embodiments, the stream exiting the wash step(s) and/or gas purge step(s) of the lithium ion exchange process may also be directed for post treatment. Collectively, the streams exiting the lithium adsorption step, wash step, and/or gas purge step of the lithium ion exchange process are referred to herein as a lithium-depleted brine stream.

As noted previously, certain governmental entities require, as a term of operating a geothermal power facility, that a certain percentage of the fluids withdrawn from a geothermal reservoir are reinjected. However, solid particulates in the reinjection stream may present problems such as scaling or solids buildup which can plug the injection well casing or the geothermal formation nearby the injection well when they are directly reinjected into the geothermal reservoir. Therefore, in one embodiment, the lithium-depleted brine stream is contacted with an acid to acidify and dissolve a least a portion of the solid particulates (e.g., precipitates) present within the lithium-depleted brine stream. The remaining solid particulate can then be physically separated (e.g., filtration) as desired.

In other embodiments wherein the lithium-depleted brine stream comprises appreciable amounts of lithium, the stream may be directed to the pH-elevation step and subjected to a further ion exchange step as described above.

In still further embodiments, the lithium-depleted brine stream may be subjected to purification step(s) such as distillation or evaporation to prepare an aqueous stream suitable for uses described herein (e.g., the acidic aqueous wash liquid or water wash).

In FIG. 1, the lithium-depleted brine stream is directed, as stream 6, to a post treatment step 7. In brine post treatment step 7, lithium-depleted brine stream 6 is contacted with an acid stream 8 to acidify the brine stream and dissolve one or more solid precipitates within the lithium-depleted brine stream 6. The intent of this acidification post treatment step is to minimize the amount of solids components present in the lithium-depleted brine stream and subjected to additional post treatment steps. Furthermore, post-treatment is undertaken to return the liquid component (i.e., the lithium-depleted brine and any other components of the lithium-depleted brine stream) back to a condition that is commercially acceptable for injection into a geothermal injection well and in compliance with any applicable environmental regulations.

The acid may be any acid suitable to dissolve a majority of the solid particulates in the lithium-depleted brine. For example, the acid may be selected from nitric acid, sulfuric acid, phosphoric acid, boric acid, hydrofluoric acid, hydrobromic acid, perchloric acid, hydriodic acid, hydrochloric acid, and combinations thereof.

The lithium-depleted brine stream and acid may be contacted in one or more CSTRs, in series or parallel. In one embodiment, the post treatment process comprises contacting the lithium-depleted brine stream and acid in two CSTRs in series. In a different embodiment, the post treatment process comprises contacting the lithium-depleted brine stream and acid in three CSTRs in series. In a further embodiment, the post treatment process comprises contacting the lithium-depleted brine stream and acid in four CSTRs in series. More or fewer CSTRs may be used depending on what solid components are present in the lithium-depleted brine stream. For example, because different components dissolve or dissociate at different pHs, it may be desirable to adjust the pH in increments to put some components into solution but not others. This also would allow components that precipitate at lower pH to be separately removed. Alternatively, using multiple CSTRs, not in series, allows the lithium-depleted brine stream to be optionally fed back through the process again. In one embodiment, the lithium-depleted brine stream 6 is pH adjusted to have the same pH as the original brine stream. In another embodiment, the lithium-depleted brine stream 6 has a pH of about 7.5 and is acidified to a pH of about 6.0 to about 6.4. about 5.5 to about 5.9 at the outlet of the CSTR, about 5.0 to about 5.4 at the outlet of the CSTR, or about 4.5 to about 4.9 at the outlet of the CSTR. It may also be dropped lower than about 4.5. The lithium-depleted brine stream 6 may also have a pH of about 7.0 and is acidified to a pH of about 6.0 to about 6.4. about 5.5 to about 5.9 at the outlet of the CSTR, about 5.0 to about 5.4 at the outlet of the CSTR, or about 4.5 to about 4.9 at the outlet of the CSTR. It may also be dropped lower than about 4.5.

Certain embodiments employ multiple CSTRs. In one embodiment, the lithium-depleted brine stream 6 has a pH of about 7.5 and is acidified in a first CSTR to a pH of below about 7.0, then further dropped in a second CSTR. For example, in the first CSTR the pH may be dropped to a range of about 5.5 to about 6.5 at the outlet of the first CSTR, then in a second CSTR the pH is further dropped to a range of about 4.5 to about 4.9 at the outlet of the second C STR.

In another embodiment, there are three CSTRs. In this embodiment, the lithium-depleted brine stream 6 has a pH of about 7.5 and is acidified in a first CSTR to a pH ranging from about 6.5 to about 7.0 at the outlet of the first CSTR, then in a second CSTR is dropped to a pH range of about 5.5 to about 6.5 at the outlet of the second CSTR, and then in a third CSTR is further dropped to a pH range of about 4.5 to about 5.5 at the outlet of the third CSTR. For example, in the first CSTR the pH may be dropped to a range of about 6.5 to about 6.8 at the outlet of the first CSTR, then in a second CSTR, the pH is dropped to a range of about 5.5 to 5.8 at the outlet of the second CSTR. and then in a third CSTR the pH is further dropped to a range of about 4.5 to about 4.8 at the outlet of the third CSTR.

In yet another embodiment, there are four CSTRs. In this embodiment, the lithium-depleted brine stream 6 has a pH of about 7.5 and is acidified in a first CSTR to a pH ranging from about 6.5 to about 7.0 at the outlet of the first CSTR, then in a second CSTR is dropped to a pH range of about 6.0 to about 6.5 at the outlet of the second CSTR, then in a third CSTR is further dropped to a pH range of about 5.2 to about 6.0 at the outlet of the third CSTR, and then in a fourth CSTR is further dropped to a pH range of about 4.5 to about 5.0 at the outlet of the fourth CSTR. For example, in the first CSTR the pH may be dropped to a range of about 6.5 to about 6.8 at the outlet of the first CSTR, then in a second CSTR, the pH is dropped to a range of about 6.0 to about 6.3 at the outlet of the second CSTR. then in a third CSTR the pH is further dropped to a range of about 5.2 to about 5.5 at the outlet of the third CSTR, and then in a fourth CSTR the pH is further dropped to a range of about 4.5 to about 4.8 at the outlet of the fourth CSTR.

Depending on the number of CSTRs in the series the pH may be dropped in different increments based on the desired characteristic of the post-treatment. The pH may be adjusted in even increments between the CSTRs or in uneven increments.

After the lithium-depleted brine stream is acidified to dissolve at least a portion of the solid particulates, the acidified lithium-depleted brine stream may still comprise suspended precipitates. Therefore, in some embodiments, the acidified lithium-depleted brine stream is subjected to a solid/liquid separation step to prepare solids for disposal and a reinjection brine stream. Solids separation from the acidified lithium-depleted brine stream may be conducted by filtration or any other conventional manner capable of separating suspended solid particulates (e.g., precipitates) from a solid containing liquid (e.g., a slurry) stream. For example, filtration may comprise a candle filter, a sock filter, a belt filter, and/or a filter press. In one embodiment, the filtration step comprises a candle filter and a filter press. In another embodiment, the filtration step comprises a filter press. The solids filter cake may be recycled or disposed of and the acidified reinjection brine stream (filtrate) can be directly reinjected into the geothermal well. In FIG. 1, the filtrate is directed via stream 9 for injection into a geothermal injection well. Stream 10 represents the solids filter cake recovered during filtration.

In a further embodiment, the lithium-depleted brine stream may be directed to a processing step comprising two CSTRs operating in series and an auxiliary CSTR for processing of certain solids. In this embodiment, the lithium-depleted brine stream is fed to a primary CSTR and then to a secondary CSTR. The stream from the secondary CSTR is subjected to a solid/liquid separation step to prepare a reinjection brine stream and a slurry containing solids. At least a portion of the slurry is then directed to a second solid/liquid separation step to prepare a solids filter cake and an enhanced slurry having a high solids content. The enhanced slurry is contacted with acid in an auxiliary CSTR to dissolve at least a portion of the solids present within the enhanced slurry. The mixture of solids, liquid, and acid exiting the auxiliary CSTR and is directed to the primary CSTR as a source of acid. The pH set point for the primary and secondary CSTR can be controlled by adjusting the amount of acid introduced into the auxiliary CSTR. Alternatively, additional acid may be introduced into the first or second CSTR as necessary. In certain embodiments, the auxiliary CSTR has a smaller volume than the primary and/or secondary CSTR. In some embodiments, the concentration of solids in the enhanced slurry introduced into the auxiliary CSTR is at about 50.0 wt % or greater, about 60.0 wt % or greater, about 70.0 wt % or greater, or about 80.0 wt % or greater.

By operating in this manner, acid is utilized to dissolve solids in an enhanced slurry having a high solids content and containing solids that were not otherwise removed in the primary or secondary CSTR or the first or second solid/liquid separation step. This allows for the acid to be directed primarily to solids that are otherwise difficult to mechanically separate. Additionally, the acid is directed to an enhanced slurry comprising less water than the inlet lithium-depleted brine stream, allowing for a more effective use of the acid (i.e., the acid does not become diluted upon contact with an aqueous lithium-depleted brine stream). In turn, the operational cost for solids disposal can be significantly reduced.

In some embodiments, additional chemical additives may be added to the acidified reinjection brine stream to reduce the likelihood of scaling or solids buildup in the geothermal well. For example, the additional chemical additive may be an oxygen scavenger.

The lithium salt product stream or eluate from the ion exchange system (e.g., stream 11 of FIG. 1) may be recovered as a lithium salt product or further processed to make other useful lithium products (e.g., lithium carbonate or lithium hydroxide).

In recovering a lithium salt product from the ion exchange system or prior to conversion of the lithium salt to lithium hydroxide or other useful product, the lithium salt-containing solution is typically subjected to one or more unit operations to remove impurities and/or concentrate the lithium salt solution and enhance recovery of the desired product.

The further processing of the lithium salt product stream may comprise one or more additional steps. For example, the further processing may comprise steps selected from precipitation, solid/liquid separation (e.g., thickening, filtration, nano- or ultra-filtration, etc.), ion exchange, and evaporation or dehydration. For example, in one embodiment, the lithium salt product stream is subjected to a first precipitation step, a second precipitation step, filtration, and ion exchange. In one embodiment, the lithium salt product stream is subjected to a first precipitation step, second precipitation step, filtration, first ion exchange step, and second ion exchange step. In another embodiment, the lithium salt product stream is subjected to a first precipitation step, second precipitation step, filtration, first ion exchange step, second ion exchange step, and/or evaporation step. In yet a further embodiment, the lithium salt product stream is subjected to a first precipitation step, second precipitation step, evaporation, and ion exchange.

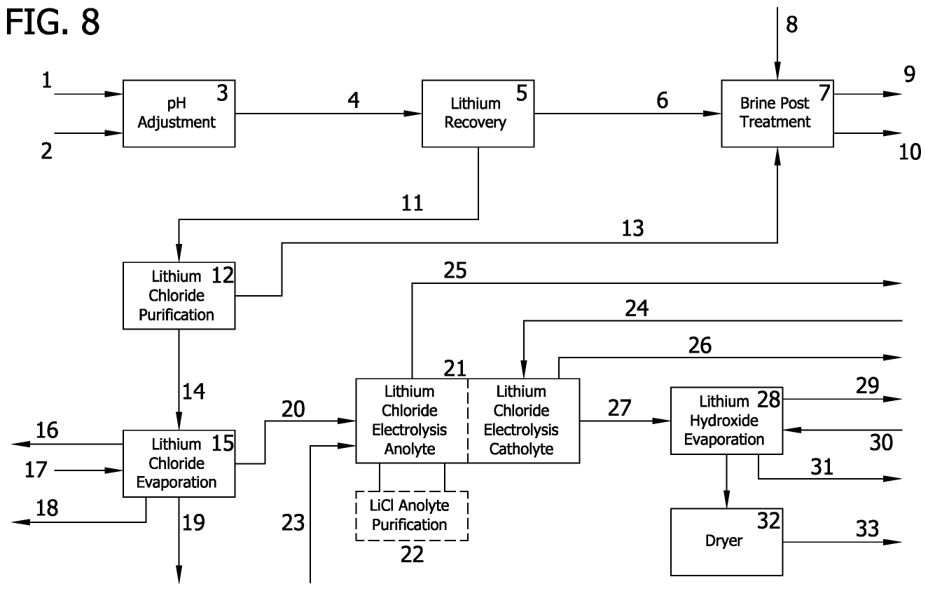

FIG. 8 is a schematic flow diagram of an integrated process for the production of lithium hydroxide from a brine source, including generating a lithium salt-containing solution by ion exchange of a pH-elevated brine source and subjecting the lithium salt-containing solution to electrolysis to produce lithium hydroxide. The process in FIG. 8 illustrates additional purification steps useful in processing the lithium salt product recovered from ion exchange for conversion to lithium hydroxide.

In the embodiment of FIG. 8, the product stream or eluate 11 from the ion exchange system comprising a lithium salt (e.g., lithium chloride) is subjected to purification 12 and evaporation 15. Lithium chloride purification may comprise one or more of precipitation and/or ion exchange steps to produce a purified lithium chloride stream 14. The purified lithium chloride stream 14 is then directed to a lithium chloride evaporation step 15 to produce a concentrated aqueous stream comprising lithium chloride.

In one embodiment, the purification 12 comprises a first precipitation and second precipitation step. In the first precipitation step, a base (e.g., NaOH, LiOH, KOH, or Ca(OH)₂) is added to the lithium salt product stream to precipitate certain hardness components, primarily but not limited to calcium and magnesium. The resulting precipitates, including calcium hydroxide and magnesium hydroxide, can be removed by any known solid/liquid separation process. The liquid resulting from the first precipitation step is then directed to the second precipitation step, where it is contacted with soda ash (Na₂CO₃) to remove further amounts of residual hardness components. For example, soda ash may be added in the second precipitation step to remove residual calcium and form calcium carbonate. The precipitates of the second precipitation step can likewise be removed by any known solid/liquid separation process and the liquid stream from the second precipitation step can be directed to further purification processing.

The solid/liquid separation (e.g., filtration) before or after each precipitation step may comprise any known manner of separating precipitates from a solid-containing liquid stream. For example, a candle filter, a sock filter, a belt filter, nano- or ultra-filtration and/or a filter press may be employed. In one embodiment, the filtration comprises a candle filter and a filter press. In another embodiment, the filtration comprises a filter press. The precipitates removed by filtration or other means may be directly disposed of or may be recycled to other locations in the overall process (e.g., pH elevation of the brine source during lithium recovery) depending on the stream composition, including any residual lithium content.

In some embodiments, the purification 12 of the lithium salt-containing solution comprises one or more further ion exchange steps (e.g., following precipitation and solids removal) as described above.

Ion exchange comprises contacting the lithium salt product stream or the liquid stream (e.g., filtrate) from the precipitation step(s) described above with an ion exchange media to selectively remove divalent metal ions selected from barium, calcium, cobalt, copper, magnesium, manganese, copper, iron, lead, tin, zinc, and combinations thereof, and particularly calcium and/or magnesium. In one embodiment, the purification ion exchange system comprises a plurality of vessels, each containing a bed of ion exchange media. The plurality of vessels are in selective fluid communication with a supply of lithium salt product stream or the liquid stream from the precipitation step(s), water, and/or acid and each mode of operation (e.g., adsorption, water rise, and regeneration, etc.) is conducted serially in each of the vessels in offset cycles. Furthermore, in additional embodiments of the purification ion exchange system, each distinct mode of operation may be conducted simultaneously in two or more vessels operating in series or parallel.

In one embodiment, the purification step comprises a first ion exchange step and a second ion exchange step. The first ion exchange step is directed to the removal of divalent metal ions such as calcium and/or magnesium. The second ion exchange step is configured to selectively remove other components such as boron. In certain embodiments, the second ion exchange step selectively removes the anions of the subject components.

In some embodiments, the lithium salt product stream or purified lithium salt product stream is concentrated by evaporation to form a concentrated lithium salt stream. In FIG. 8, the purified lithium chloride stream 14 resulting from purification 12 is directed to lithium chloride evaporation 15.

Evaporation may be carried out using any conventional evaporation unit operation including, for example, an evaporation process comprising a falling film evaporator, forced circulation evaporator, natural circulation evaporation, or multiple effect evaporator (e.g., triple-effect evaporator). Evaporation of the lithium salt product stream or purified lithium salt product stream may be carried out using one or more evaporation unit operations. In certain embodiments, the evaporator(s) may be powered by energy generated by the upstream geothermal plant.

For example, in one embodiment, the lithium salt product stream or purified lithium salt product stream is evaporated using a triple-effect evaporator. A triple-effect evaporator utilizes a series of three vessels, wherein each vessel produces a vapor and aqueous stream. The aqueous lithium salt product stream and a steam are fed to the first vessel. Optionally, the first vessel is supplied with extraneous power to further heat the contents of the vessel. The first vessel produces a first vapor outlet stream and a first aqueous outlet stream. The first vapor outlet and first aqueous outlet streams are then directed to the inlet of a second vessel. Optionally, the first aqueous outlet stream may be processed before introduction into the second vessel. For example, the first aqueous outlet stream may be subjected to solid/liquid separation (e.g., filtration or centrifuge) to remove certain constituents, such as sodium chloride. The second vessel may be optionally supplied with extraneous power to further heat the contents of the vessel. The second vessel produces a second vapor outlet stream and a second aqueous outlet stream. The second vapor outlet and second aqueous outlet streams are then directed to the inlet of a third vessel. Optionally, the second aqueous outlet stream may be processed before introduction into the third vessel. For example, the second aqueous outlet stream may be subjected to solid/liquid separation (e.g., filtration or centrifuge) to remove certain constituents, such as sodium chloride. The third vessel may be optionally supplied with extraneous power to further heat the contents of the vessel. The third vessel produces a third vapor outlet stream, a third aqueous outlet stream (referred to herein as a “concentrated aqueous stream”) comprising a lithium salt, and steam. The steam may be condensed to form a steam condensate stream. The concentrated aqueous stream comprising a lithium salt may be recovered as a final product or further processed to lithium hydroxide in accordance with the embodiment illustrated in FIG. 8.

As illustrated in FIG. 8, purified lithium salt product stream 14, steam supply stream 17, and optionally additional energy are supplied to evaporation 15 in the form of a triple-effect evaporator. The third vessel in the triple effect evaporator produces a vapor stream 16, steam 18, and a concentrated aqueous stream 20 comprising the lithium chloride salt. Steam 18 is condensed to form a steam condensate stream. During triple-effect evaporation, the various aqueous streams may be processed before introduction into the next vessel. For example, a sodium chloride slurry stream 19 may be recovered during triple-effect evaporation. The slurry may be washed, for example with deionized water, and subjected to a separation step to recover any residual lithium that may be present in the sodium chloride slurry. Stream 20 represents the concentrated aqueous stream (i.e., the further concentrated lithium chloride stream) recovered from the triple-effect evaporator.

Vapor condensate from the above-mentioned evaporation is typically a relatively pure aqueous stream. As such, the vapor condensate may be utilized in one or more of the ion exchange processes as a source of water or elsewhere in the process as described herein wherever a relatively pure water stream is desired. Steam condensate from the above-mentioned evaporation is typically contaminated with impurities from the source steam, and therefore may be directed for disposal. In certain embodiments, the steam condensate may be utilized as a heat source for various heat exchanges present throughout the process.

In the integrated process illustrated in FIG. 8, the purified and concentrated aqueous stream comprising the lithium chloride salt is directed to an electrolytic system 21 to form a product solution comprising lithium hydroxide.

The purified and concentrated aqueous stream comprising the lithium chloride salt fed to the electrolytic system typically has a lithium salt concentration of about 10.0 wt % or greater, 12.0 wt % or greater, 14.0 wt % or greater, 16.0 wt % or greater, 18.0 wt % or greater, about 20.0 wt % or greater, 22.0 wt % or greater, about 24.0 wt % or greater, 26.0 wt % or greater, 28.0 wt % or greater, about 30.0 wt % or greater, about 32.0 wt % or greater, about 34.0 wt % or greater, about 36.0 wt % or greater, about 38.0 wt % or greater, or about 40.0 wt % or greater of a lithium salt. For example, the concentration of the lithium salt is typically from about 20.0 wt % to about 50.0 wt %, from about 25.0 wt % to about 50.0 wt %, from about 25.0 wt % to about 45.0 wt %, from about 26.0 wt % to about 44.0 wt %, from about 27.0 wt % to about 43.0 wt %, from about 28.0 wt % to about 42.0 wt %, from about 29.0 wt % to about 41.0 wt %, from about 30.0 wt % to about 40.0 wt %, or from about 30.0 wt % to about 35.0 wt %.

Electrolytic system 21 may comprise a variety of electrolytic devices in a variety of configurations. In one embodiment, the electrolytic system comprises an anolyte chamber and catholyte chamber separated by an ion exchange membrane and comprising an anode and cathode. The ion exchange membrane may be selected from a cation exchange membrane, an anionic exchange membrane, a bipolar exchange membrane, and combinations thereof. In certain embodiments, the ion exchange membrane is a cation exchange membrane.

In one embodiment, a lithium hydroxide product is prepared by directing the lithium salt product stream to the anolyte chamber of an electrolysis unit operation comprising a cation exchange membrane. A water stream is introduced into the catholyte chamber. In certain embodiments, an acid stream is also introduced into the anolyte chamber. During electrolysis, the lithium and chlorine ions within the concentrated aqueous stream comprising the lithium chloride salt are fed to the anolyte chamber of the electrolysis cell. The chlorine ions in solution, encountering the anode, are oxidized to form chlorine gas. The lithium ions preferentially transport through the permeable electrolysis cell ion-exchange membrane (i.e., cation exchange membrane) and towards the cathode. De-ionized water is fed to the catholyte side of the cell. Water molecules encountering the cathode are reduced to form hydroxyl anions and hydrogen gas. The lithium ions traversing the ion-exchange membrane and the hydroxyl ions form the lithium hydroxide product that is recovered and removed from the system. In embodiments wherein the concentrated aqueous stream comprises lithium chloride, a chlorine gas product is produced in the anolyte chamber and a hydrogen gas product is produced in the catholyte chamber.

In certain embodiments, the electrolytic system 21 further comprises a lithium salt anolyte purification device. The anolyte purification device removes both cation and anion contaminants that may build up within the anolyte compartment and are detrimental to the ion-exchange membrane or negatively impact the efficiency of the process. In certain embodiments, the contaminants are removed by taking a portion of the anolyte purification device liquid stream and recycling the stream as an inlet to the lithium chloride purification steps described above.

The lithium hydroxide salt stream exiting the electrolysis unit operation may be recovered as a final product or further purified and concentrated. In one embodiment, the lithium hydroxide salt stream exiting the electrolysis unit operation is directed to a lithium hydroxide evaporation and/or crystallization step to prepare a concentrated lithium hydroxide mono hydrate salt slurry stream. The lithium hydroxide evaporation step may comprise any conventional evaporation unit operation. The evaporation step may be conducted using, for example, a falling film evaporator, forced circulation evaporator, natural circulation evaporation, or multiple effect evaporator (e.g., triple-effect evaporator). In one embodiment, the evaporation and/or crystallization step comprises a falling film evaporator followed by a forced recirculation crystallizer. Further, in certain embodiments, a centrifugal solid/liquid separation step (e.g., a centrifuge) is utilized to process a portion of the recirculating fluid from the forced recirculation crystallizer, to separate a lithium hydroxide crystal stream from the recirculation fluid. In certain embodiments the washed lithium hydroxide crystal stream may be redissolved in deionized water and directed to a second crystallizer to achieve a higher purity lithium hydroxide salt slurry for processing.

In certain embodiments, the lithium hydroxide salt stream or concentrated lithium hydroxide salt stream is further dried to remove at least a portion of the aqueous component contained therein and provide a lithium hydroxide slurry or solid lithium hydroxide product. The drying step may comprise any conventional drying unit operation. For example, a fluidized bed dryer, spray dryer, hollow flight screw dryer, etc.

In the embodiment of FIG. 8, the purified and concentrated aqueous stream comprising the lithium chloride salt 20 is subjected to electrolysis and further processing to prepare a lithium hydroxide product. Inlet stream 23 represents an acid stream (e.g., hydrochloric acid) and inlet stream 24 represents a water stream (e.g., deionized water or vapor condensate). Outlet stream 25 represents the chlorine gas and outlet stream 26 represents the hydrogen gas resulting from the electrolysis operation. The hydrogen and/or chlorine gas may be recycled for further use or may be disposed of (e.g., by combustion). Outlet stream 27 represents the lithium hydroxide aqueous stream resulting from the electrolysis operation.

Electrolysis system 21 may operate in any conventional manner suitable to dissociate the lithium and chloride ions and form a lithium hydroxide solution. For example, in one embodiment, the electrolysis system 21 comprises an anolyte chamber and catholyte chamber separated by an ion exchange membrane and comprising an anode and cathode. A lithium chloride anolyte purification device 22 may also be present in the electrolysis operation. For example, this device may comprise ion exchange.

The aqueous lithium hydroxide stream 27 is directed to a lithium hydroxide evaporation operation 28. In this operation, lithium hydroxide stream 27 is heated to evaporate at least a portion of the aqueous component contained therein. The lithium hydroxide evaporation operation 28 may comprise a falling film evaporator followed by one, or more, forced recirculation crystallizers. Stream 30 represents the inlet steam, outlet stream 29 represents the water vapor stream, and outlet stream 31 represents the steam condensate stream.

The concentrated aqueous stream (i.e., further concentrated lithium hydroxide stream) resulting from the lithium hydroxide evaporation step is then separated via a solid/liquid separation step (e.g., centrifugation) and directed to dryer 32 for further concentration to produce the dried lithium hydroxide mono hydrate. The dry powdered lithium hydroxide product resulting from dryer 32 is then recovered via stream 33 for further processing or commercial use.

It will be well understood that in the process of preparing a lithium hydroxide product, it is desirable to limit the amount of air present during processing. Contact with external air may cause the lithium hydroxide to absorb carbon dioxide present in the air and contaminate the final lithium hydroxide product with lithium carbonate. Therefore, after the lithium hydroxide salt stream is recovered from the electrolysis unit operation, it may be desirable to utilize nitrogen or another inert gas in one or more of the further processing/purification steps in order to reduce and/or eliminate the presence of air.

Having described the present disclosure in detail, it will be apparent that modifications and variations are possible without departing from the scope of the invention defined in the appended claims.

When introducing elements of the present disclosure, the articles “a”, “an”, “the”, and “said” are intended to mean that there are one or more of the elements. The terms “comprising”, “including” and “having” are intended to be inclusive and mean that there may be additional elements other than the listed elements.

In view of the above, it will be seen that the several objects of the present disclosure are achieved, and other advantageous results attained.

As various changes could be made in the above constructions and methods without departing from the scope of the present disclosure, it is intended that all matter contained in the above description and shown in the accompanying drawings shall be interpreted as illustrative and not in a limiting sense.

What is claimed:

1. A process for recovering lithium, the process comprising:
increasing the pH of a brine source comprising lithium ions to at least about 5.5 or greater to produce a pH-elevated brine source;
contacting the pH-elevated brine source with a bed of protonated ion exchange media to produce a lithiated ion exchange media and a lithium-depleted brine stream;
contacting the lithiated ion exchange media with an acidic aqueous wash liquid to produce a washed lithiated ion exchange media; and
contacting the washed lithiated ion exchange media with an elution liquid comprising an acid to form a regenerated protonated ion exchange media having a reduced lithium ion content and an ion exchange salt solution containing lithium ions eluted from the lithiated ion exchange media.

2. The process of claim 1, wherein contacting the lithiated ion exchange media with an acidic aqueous wash liquid comprises:
a recycle wash liquid that fluidizes the bed of lithiated ion exchange media to form an intermediate washed lithiated ion exchange media and an impurity-containing wash stream; and wherein
contacting the intermediate washed lithiated ion exchange media with an acidic aqueous wash liquid forms the washed lithiated ion exchange media and the recycle wash liquid.

3. The process of claim 1, wherein the process is conducted in an ion exchange system comprising a plurality of vessels each containing a bed of the ion exchange media and in selective fluid communication with a supply of the pH-elevated brine source, aqueous acidic wash liquid, and elution liquid comprising an acid; and wherein producing lithium ion media, contacting the lithiated ion exchange media with an acidic aqueous wash liquid, and forming a regenerated protonated ion exchange media having a reduced lithium ion content and an ion exchange salt solution containing lithium ions are conducted serially in each of the vessels in parallel offset cycles, thereby forming a series of vessels, each with a lithiated ion exchange media, a washed lithiated ion exchange media, and a regenerated protonated ion exchange media; and
wherein contacting the lithiated ion exchange media with an acidic aqueous wash liquid comprises:
a recycle wash liquid that fluidizes the bed of lithiated ion exchange media to form an intermediate washed lithiated ion exchange media and an impurity-containing wash stream; and
wherein contacting the intermediate washed lithiated ion exchange media with an acidic aqueous wash liquid forms the washed lithiated ion exchange media and the recycle wash liquid.

4. The process of claim 3, wherein a first intermediate washed lithiated ion exchange media in the series is contacted with the acidic aqueous wash liquid comprising an acid to form a first washed lithiated ion exchange media.

5. The process of claim 3, wherein the first lithiated ion exchange media is fluidized by contacting the first lithiated ion exchange media with the recycle wash liquid.

6. The process of claim 2, wherein the pH of the recycle wash liquid is higher than the pH of the acidic aqueous wash liquid.

7. The process of claim 1, wherein the pH of the acidic aqueous wash liquid has a pH of between about 4.5 and about 6.5.

8. The process of claim 1, wherein the acidic aqueous wash liquid comprises deionized water, reverse osmosis water, reclaimed water from another location in the process, other liquid having a pH of below about 7.0, or combinations thereof.

9. The process of claim 1, wherein the acidic aqueous wash liquid comprises brine.

10. The process of claim 9, wherein the acidic aqueous wash liquid comprising brine comprises a brine selected from the brine source, an acidified brine, a brine suitable for reinjection into a geothermal well, and combinations thereof.

11. The process of claim 1, wherein the brine source has a pH ranging from about 4.2 to about 5.0.

12. The process of claim 1, wherein the pH of the pH-elevated brine source is from about 7.5 to about 8.

13. The process of claim 1, wherein the acid is selected from nitric acid, sulfuric acid, phosphoric acid, boric acid, hydrofluoric acid, hydrobromic acid, perchloric acid, hydriodic acid, hydrochloric acid, and combinations thereof.

14. The process of claim 9, wherein the process is conducted in an ion exchange system comprising a plurality of vessels each containing a bed of the ion exchange media and in selective fluid communication with a supply of the pH-elevated brine source, aqueous acidic wash liquid, and elution liquid comprising an acid; and wherein producing lithium ion media, contacting the lithiated ion exchange media with an acidic aqueous wash liquid, and forming a regenerated protonated ion exchange media having a reduced lithium ion content and an ion exchange salt solution containing lithium ions are conducted serially in each of the vessels in parallel offset cycles.

15. The process of claim 14, wherein the bed of ion exchange media is disposed within one or more vessels and fluidized when contacted with the pH-elevated brine source.

16. The process of claim 1, wherein the ion exchange media comprises titanium oxide and/or lithium titanate.

17. The process of claim 1, wherein the ion exchange media comprises a polymeric binder.

18. A process for increasing the pH of brine, the process comprising:
obtaining brine from a brine source comprising lithium ions;
adding the brine to a continuously stirred tank reactor without preprocessing the brine to remove solid matter;
adding a strong base to the continuously stirred tank reactor;
contacting the brine with the base to form a pH-elevated brine; wherein the pH-elevated brine has a pH of at least about 5.5 or greater,
wherein the pH elevation does not create large solid particles or increase the temperature of the brine.

19. The process of claim 17, wherein the process creates particles having a diameter of less than about 50.0 microns.

20. A process for creating a lithiated ion exchange media, the process comprising:
contacting a pH-elevated brine source with a bed of protonated ion exchange media;
producing a lithiated ion exchange media and a spent brine, wherein the bed of protonated ion exchange media comprises a metal oxide absorbent and a polymeric binder.
